(19) United States
(12) Patent Application Publication
(10) Pub. No.: US 2026/0343584 A1
(43) Pub. Date: Oct. 29, 2026

(54) APPARATUS AND METHOD FOR NETWORK NODE IN WIRELESS COMMUNICATION NETWORK

(71) Applicant: Samsung Electronics Co., Ltd., Suwon-si (KR)

(72) Inventors: Wei LI, Beijing (CN); Zihao ZHANG, Beijing (CN); Jiajia WANG, Beijing (CN); Xiaohui LIANG, Beijing (CN); Yupu LIU, Beijing (CN); Peipei XU, Beijing (CN)

(21) Appl. No.: 19/653,853

(22) Filed: Apr. 21, 2026

Related U.S. Application Data
(63) Continuation of application No. PCT/KR2026/095594, filed on Apr. 7, 2026.

(30) Foreign Application Priority Data
Apr. 25, 2025 (CN) 202510536352.7
Jun. 27, 2025 (CN) 202510888010.1
Oct. 29, 2025 (CN) 202511566741.0
Jan. 23, 2026 (CN) 202610100067.5

(51) Int. Cl. H04W 72/541; H04B 7/0452; H04B 17/345

(52) U.S. Cl. CPC H04W 72/541; H04B 7/0452; H04B 17/345

(57) ABSTRACT

A method performed by a network node in a wireless communication network is provided. The method includes determining, by the network node, interference-related information corresponding to a first multiplexing (MU) user equipment (UE) based on first information of the first MU UE and a second MU UE, wherein the second MU UE and the first MU UE are configured to perform MU multiple input and multiple output (MIMO) multiplexing transmission, and wherein the first information includes at least one of MU pairing information, signal intensity-related information, or channel-related information, and performing, by the network node, interference mitigation processing on a signal transmitted by the first MU UE by using a first neural network, based on the interference-related information corresponding to the first MU UE.

### CROSS-REFERENCE TO RELATED APPLICATION(S)

This application is a continuation application, claiming priority under 35 U.S.C. § 365(c), of an International application No. PCT/KR2026/095594, filed on Apr. 7, 2026, which is based on and claims the benefit of a Chinese patent application number 202510536352.7, filed on Apr. 25, 2025, in the Chinese Intellectual Property Office, of a Chinese patent application number 202510888010.1, filed on Jun. 27, 2025, in the Chinese Intellectual Property Office, of a Chinese patent application number 202511566741.0, filed on Oct. 29, 2025, in the Chinese Intellectual Property Office, and of a Chinese patent application number 202610100067.5, filed on Jan. 23, 2026, in the Chinese Intellectual Property Office, the disclosure of each of which is incorporated by reference herein in its entirety.

### TECHNICAL FIELD

The disclosure relates to the technical field of wireless communication. More particularly, the disclosure relates to an apparatus and a method for a network node in a wireless communication network.

### BACKGROUND

To meet the coverage and emerging service demands in future 5^{th} generation (5G), 5G-advanced (5GA), and 6^{th} generation (6G) network, the number of next-generation node B (gNBs) and user equipments (UEs) in the network will increase dramatically. The traffic in the network is growing exponentially. To satisfy the transmission requirement of massive devices, the network will increasingly adopt multiple input and multiple output (MIMO) technology or emerging network architectures (e.g., cell-free network). However, to satisfy a lot of service requirement, multiplexing rate of resource within covered cells or across multiple covered cells will grow constantly, leading to severe interference that degrades user experience and quality of service (QoS). Therefore, how to effectively perform interference management is critical for network performance.

Current interference management schemes in communication system are divided into two main classes: traditional and artificial intelligence (AI)/machine learning (ML)-based schemes, which both primarily focus on beamforming (BF), equalization, successive interference cancellation (SIC), and resource coordination.

Since the current interference management schemes still have issues such as significant unmitigated interference, and the difficulty in evaluating such unmitigated interference, it is necessary to provide a new interference management method.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method performed by a network node and an electronic device.

Another aspect of the disclosure is to optimize interference management schemes, to make the effect of interference sensing and mitigation better.

Additional aspects will be set forth in part in the description which follows and, in part, will be apparent from the description, or may be learned by practice of the presented embodiments.

In accordance with an aspect of the disclosure, a method performed by a network node in a wireless communication network is provided. The method includes determining, by the network node, beamforming (BF) weights based on a first user equipment relation and channel estimation results of reference signals, wherein the first user equipment relation is constructed based on a resource multiplexing relation among multiple user equipments and channel feature indexes of respective user equipments, and processing, by the network node, a first signal based on the BF weights, wherein the first signal is a signal received from a first user equipment or a signal transmitted to the first user equipment.

In accordance with an aspect of the disclosure, a method performed by a network node in a wireless communication network is provided. The method includes determining, by the network node, a first resource allocated to a first user equipment for transmission, transmitting, by the network node, first information to the first user equipment, wherein the first information includes the first resource, and receiving, by the network node, a first signal transmitted by the first user equipment on the first resource, or transmitting the first signal to the first user equipment on the first resource, wherein the determining of the first resource is based on (i) a first user equipment relation, the first user equipment relation being constructed based on a resource multiplexing relation among multiple user equipments and channel feature indexes of respective user equipments, or (ii) an obtained magnitude of interference experienced by the first user equipment, estimated interference mitigation parameters, and performance metrics of the first user equipment.

In accordance with an aspect of the disclosure, a method performed by a network node in a wireless communication network is provided. The method includes determining, by the network node, interference-related information corresponding to a first multiplexing (MU) user equipment (UE) based on first information of the first MU UE and a second MU UE, wherein the second MU UE and the first MU UE are configured to perform MU multiple input and multiple output (MIMO) multiplexing transmission, and wherein the first information includes at least one of MU pairing information, signal intensity-related information, or channel-related information, and performing, by the network node, interference mitigation processing on a signal transmitted by the first MU UE by using a first neural network, based on the interference-related information corresponding to the first MU UE.

In accordance with an aspect of the disclosure, an electronic device is provided. The electronic device includes memory, including one or more storage media, storing one or more computer programs, and one or more processors communicatively coupled to the memory, wherein the one or more computer programs include computer-executable instructions that, when executed by the one or more processors individually or collectively, cause the electronic device to determine interference-related information corresponding to a first multiplexing (MU) user equipment (UE) based on first information of the first MU UE and a second MU UE, wherein the second MU UE and the first MU UE are configured to perform MU multiple input and multiple output (MIMO) multiplexing transmission, and wherein the first information includes at least one of MU pairing information, signal intensity-related information, or channel-related information, and perform interference mitigation processing on a signal transmitted by the first MU UE by using a neural network, based on the interference-related information corresponding to the first MU UE.

In accordance with an aspect of the disclosure, one or more computer-readable storage media storing one or more computer programs including computer-executable instructions that, when executed by one or more processors of an electronic device individually or collectively, cause the electronic device to perform operations, the operations including determining interference-related information corresponding to a first multiplexing (MU) user equipment (UE) based on first information of the first MU UE and a second MU UE, wherein the second MU UE and the first MU UE are configured to perform MU multiple input and multiple output (MIMO) multiplexing transmission, and wherein the first information includes at least one of MU pairing information, signal intensity-related information, or channel-related information, and performing interference mitigation processing on a signal transmitted by the first MU UE by using a first neural network, based on the interference-related information corresponding to the first MU UE.

The solutions provided by the embodiments of the disclosure enable more accurate interference sensing and mitigation as compared to the prior art, thereby better meeting the actual demands of interference management. Optional implementations of the disclosure and corresponding effects thereof will be described in detail below in conjunction with the embodiments.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A is a schematic diagram of an interference management system provided by the related solutions according to an embodiment of the disclosure;

FIG. 1B is a schematic diagram of a 16-quadrature amplitude modulation (QAM) constellation diagram according to an embodiment of the disclosure;

FIG. 1C is a schematic diagram of a received interference noise signal offset according to an embodiment of the disclosure;

FIG. 1D is a schematic diagram of a forward process of a diffusion model according to an embodiment of the disclosure;

FIG. 1E is a structural schematic diagram of an overall architecture of an interference pattern guided diffusion model (IGDM) according to an embodiment of the disclosure;

FIG. 2A is a schematic flow diagram of a method performed by a network node according to an embodiment of the disclosure;

FIG. 2B is a schematic flow diagram of a method performed by a network node according to an embodiment of the disclosure;

FIG. 2C is a schematic diagram of an interference management system based on an interference channel diffusion model according to an embodiment of the disclosure;

FIG. 2D is a schematic flow diagram of a method performed by a network node according to an embodiment of the disclosure;

FIG. 3 is a schematic diagram of an interference-multiplexing user relation graph according to an embodiment of the disclosure;

FIG. 4 is a schematic diagram of another interference-multiplexing user relation graph according to an embodiment of the disclosure;

FIG. 5 is a schematic diagram of a mutual interference effect graph based on matched channel feature indexes according to an embodiment of the disclosure;

FIG. 6 is a schematic diagram of an extended mutual interference effect graph according to an embodiment of the disclosure;

FIG. 7 is a schematic diagram of an interference management system according to an embodiment of the disclosure;

FIG. 8 is a schematic diagram of diffusion model training and de-noising/de-interference processing according to an embodiment of the disclosure;

FIG. 9 is a schematic diagram of a deployment way of a solution according to an embodiment of the disclosure;

FIG. 10 is a schematic diagram of a deployment way of another solution according to an embodiment of the disclosure;

FIG. 11 is a schematic diagram of a deployment way of another solution according to an embodiment of the disclosure;

FIG. 12 is a schematic diagram of a deployment way of another solution according to an embodiment of the disclosure;

FIG. 13 is a schematic diagram of a deployment way of another solution according to an embodiment of the disclosure;

FIG. 14 is a structural schematic diagram of an electronic device according to an embodiment of the disclosure;

FIG. 15 is a schematic diagram of a model structure for training a diffusion model according to an embodiment of the disclosure;

FIG. 16A is a schematic diagram of a resource coordination process according to an embodiment of the disclosure;

FIG. 16B is a schematic diagram of a BF method based on interference matrix reconstruction according to an embodiment of the disclosure;

FIG. 16C is a schematic diagram of an overall structure of an IGDM according to an embodiment of the disclosure;

FIG. 17 is a schematic diagram of an environment-aware model size decision module according to an embodiment of the disclosure;

FIG. 18 is a schematic diagram of a model size decision structure according to an embodiment of the disclosure;

FIG. 19 is a schematic diagram of a case of multiplexing users on different frequency bands according to an embodiment of the disclosure;

FIG. 20 is a schematic diagram of a multiplexing user pattern according to an embodiment of the disclosure;

FIG. 21 is a schematic diagram of an interference channel pattern according to an embodiment of the disclosure;

FIG. 22 is a schematic diagram of an interference intensity weight pattern according to an embodiment of the disclosure;

FIG. 23 is a schematic diagram of channel data and received data preprocessing and processed symbol representation according to an embodiment of the disclosure;

FIG. 24 is a schematic diagram of constellation point value preprocessing according to an embodiment of the disclosure;

FIG. 25 is a schematic diagram of diffusion model (DM) processing based on multiple-state weighting according to an embodiment of the disclosure;

FIG. 26 is a schematic diagram of a weighted state value calculation according to an embodiment of the disclosure;

FIG. 27 is a schematic diagram of an interference noise prediction and state value calculation for step t according to an embodiment of the disclosure;

FIG. 28A is a structural schematic diagram of an IGDM-based communication system according to an embodiment of the disclosure;

FIG. 28B is a schematic diagram of interference characteristic extraction in variable user pairing according to an embodiment of the disclosure;

FIG. 29 is a schematic diagram of the smoothing effect of multiple-state DM processing according to an embodiment of the disclosure;

FIG. 30 is a schematic diagram of an environment-aware model size decision module according to an embodiment of the disclosure;

FIG. 31 is a schematic diagram of decision areas for different modulation formats according to an embodiment of the disclosure;

FIG. 32 is a schematic diagram of MCS-based interference mitigation under different steps according to an embodiment of the disclosure;

FIG. 33 is a schematic diagram of input and output of an adaptive model size decision module according to an embodiment of the disclosure;

FIG. 34 is a schematic diagram of q=2 multiple-state processing according to an embodiment of the disclosure;

FIG. 35A is a schematic diagram of input and output of a DM-based de-noising model according to an embodiment of the disclosure;

FIG. 35B is a schematic diagram of an interference channel pattern and interference weight pattern guided noise and interference prediction DM process according to an embodiment of the disclosure;

FIG. 36 is a schematic diagram of reducing diffusion model steps based on MCS according to an embodiment of the disclosure;

FIG. 37 is a schematic diagram of a distillation model according to an embodiment of the disclosure;

FIG. 38 is a schematic diagram of an MCS and constellation diagram according to an embodiment of the disclosure;

FIG. 39 is a schematic diagram of a process of DM processing based on multiple-state registers according to an embodiment of the disclosure;

FIG. 40A is a schematic diagram of a deployment location of an IGDM on the network side according to an embodiment of the disclosure;

FIG. 40B is a schematic diagram of a deployment location of an IGDM on the network side according to an embodiment of the disclosure;

FIG. 41 is a structural schematic diagram of an IGDM interference mitigation communication system according to an embodiment of the disclosure;

FIG. 42 is a schematic diagram of distance between constellation points for different modulation orders according to an embodiment of the disclosure; and

FIG. 43 is a schematic diagram of a process of multiple-state-based diffusion processing according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It may include various specific details to assist in that understanding but these are to be regarded as merely exemplary. Accordingly, those of ordinary skill in the art will recognize that various changes and modifications of the various embodiments described herein may be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” may include reference to one or more of such surfaces.

When an element is referred to as being “connected” or “coupled” to another element, the element may be directly connected or coupled to the other element, or it may also mean that a connection relationship between the element and the other element is established through intervening elements. In addition, the word “connected” or “coupled” as used herein may comprise wirelessly connected or coupled.

The term “include” or “may include” refers to the existence of a corresponding disclosed function, operation or component which may be used in various embodiments of the disclosure and does not limit the existence of one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the disclosure may include any or all of combinations of listed words. For example, the expression “A or B” may include A, may include B, or may include both A and B. In describing a plurality (two or more) of items, the plurality of items may refer to one, more, or all of them if the relationship between the plurality of items is not explicitly defined. For example, the description of “parameter A including A1, A2, A3” may be realized as parameter A including A1 or A2 or A3, and may also be realized as parameter A including at least two of the three items A1, A2, A3.

Unless defined differently, all terms used herein, which include technical terminologies or scientific terminologies, have the same meaning as that understood by a person skilled in the art to which the disclosure belongs. Such terms as those defined in a generally used dictionary are to be interpreted to have the meanings equal to the contextual meanings in the relevant field of art, and are not to be interpreted to have ideal or excessively formal meanings unless clearly defined in the disclosure.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

At least some of functions in an apparatus or an electronic device according to an embodiment of the disclosure may be realized by an AI model. For example, at least one of a plurality of modules of the apparatus or the electronic device may be realized by the AI model. The functions associated with the AI may be performed by a non-volatile memory, a volatile memory, and a processor.

The one or more processors control processing of input data based on specified operating rules or artificial intelligence (AI) models stored in the non-volatile memory and the volatile memory. The specified operating rules or AI models are provided through training or learning.

Here, provided by learning refers to obtaining the specified operating rules or the AI models with desired characteristics by applying a learning algorithm to a plurality of learning data. The learning may be performed in the apparatus or electronic device itself in which the AI according to embodiments is executed, and/or may be realized by a separate server/system.

The AI model may contain a plurality of neural network layers. Each layer has a plurality of weight values, and each layer performs a neural network computation by a computation between the input data of that layer (e.g., the computation results of a previous layer and/or the input data of the AI model) and the plurality of weight values of the current layer. Examples of neural networks include, but are not limited to, convolutional neural networks (CNNs), deep neural networks (DNNs), recurrent neural networks (RNNs), Restricted Boltzmann Machines (RBMs), Deep Belief Networks (DBNs), Bi-directional Recurrent Deep Neural Networks (BRDNNs), Generative Adversarial Networks (GANs), and deep Q-networks.

The learning algorithm is a method of training a predetermined target apparatus (e.g., a robot) using the plurality of learning data to enable, allow, or control the target apparatus to make determinations or predictions. Examples of the learning algorithm include, but are not limited to, supervised learning, unsupervised learning, semi-supervised learning, or reinforcement learning.

According to the disclosure, at least one step/operation in the method performed in an electronic device, such as the operation of performing interference sensing and mitigation, etc., may be implemented using an artificial intelligence model. A processor of the electronic device may perform preprocessing operations on the data to convert it into a form suitable for use as input to the artificial intelligence model. The artificial intelligence model may be obtained by training. Here, “obtained by training” means training a basic AI model with a plurality of pieces of training data by a training algorithm to obtain a specified operating rule or AI model configured to perform a desired feature (or purpose).

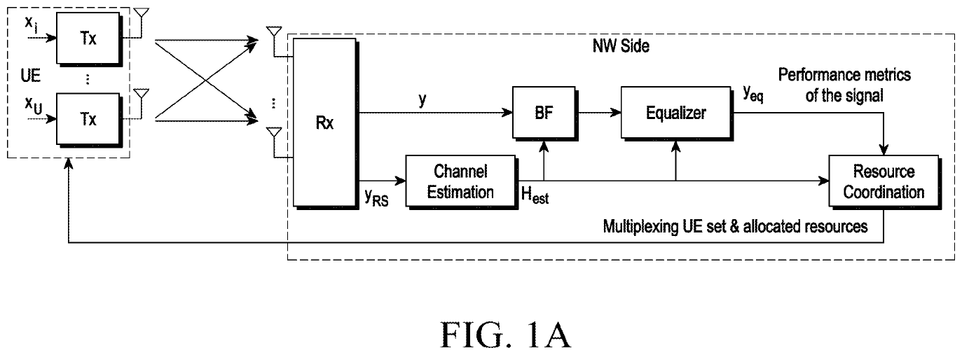

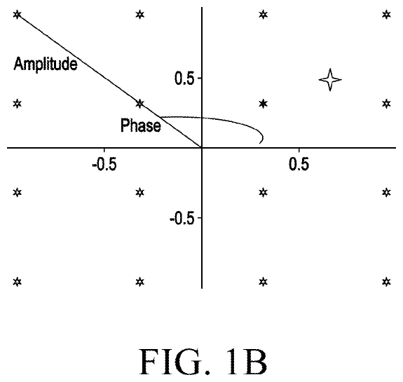

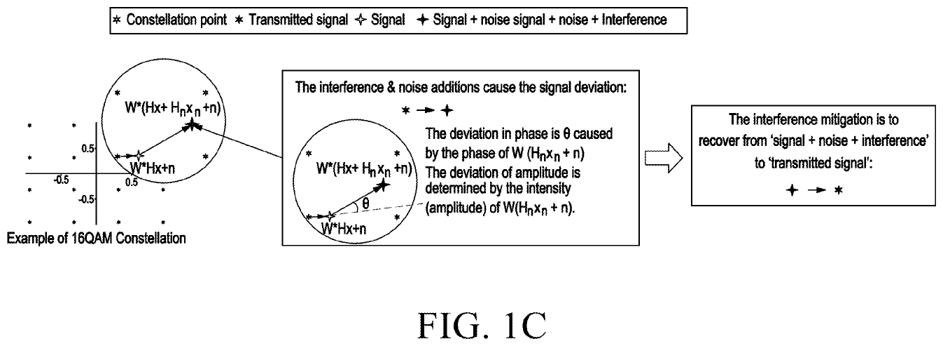

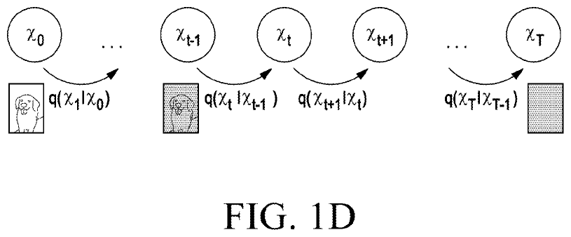

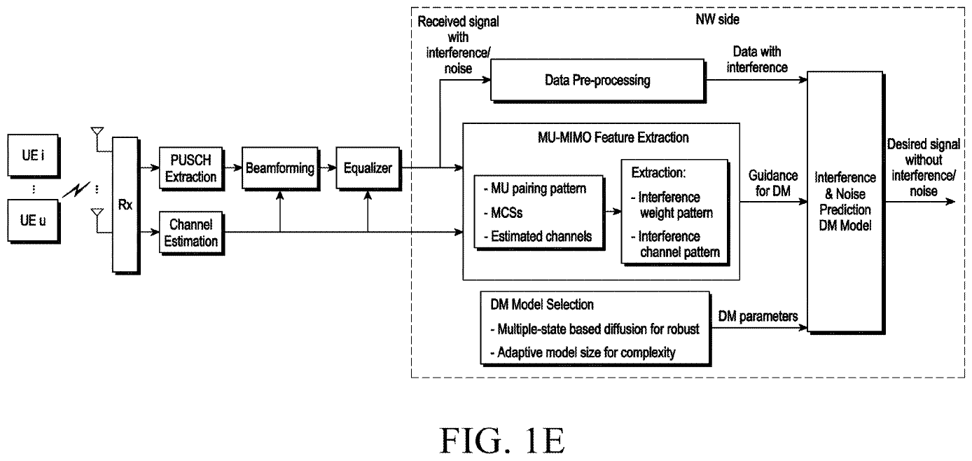

FIG. 1A is a schematic diagram of an interference management system provided by the related solutions according to an embodiment of the disclosure.

FIG. 1B is a schematic diagram of a 16QAM constellation diagram according to an embodiment of the disclosure.

FIG. 1C is a schematic diagram of a received interference noise signal offset according to an embodiment of the disclosure.

FIG. 1D is a schematic diagram of a forward process of a diffusion model according to an embodiment of the disclosure.

FIG. 1E is a structural schematic diagram of an overall architecture of an IGDM according to an embodiment of the disclosure.

In communication systems, a user's transmitted signal x passes through the channel H and subjects to the effect of superimposing other user' signal Hₙxₙ and noise n, and then arrives at the receive terminal. At the receive terminal, the received signal is processed by BF and minimum mean square error (MMSE). If W denotes the effect of BF and MMSE processing, the received signal is y′=W*(Hx+Hₙxₙ+n). Here, the transmitted signal x is a modulated complex signal, and both the channel and noise are complex signals. Taking the 16QAM modulation as an example, each modulated symbol is a constellation point in a constellation diagram, as shown in FIG. 1B, and the constellation point may be represented using vector amplitude and phase.

The transmitted signal being affected by the complex channel H and noise may be regarded as that the constellation point undergoes amplitude and phase shifts in the diagram, moving from position 1 to position 2. When interference from other user' signal is superimposed, the position of the transmitted signal in the constellation diagram shifts to position 3, as shown in FIG. 1C. The shift may include an amplitude (intensity of W*(Hₙxₙ+n)) and a phase θ (phase of W*(Hₙxₙ+n)).

Therefore, the de-noising process of the received signal in the communication is to restore the signal from position 3 to position 1.

Current interference management schemes in communication systems are divided into two main classes: traditional and AI/ML-based schemes, which both primarily focus on beamforming (BF), equalization, and resource coordination. Interference primarily originates from users using the same resources within the same cell or different cells, also referred to as multiplexing users.

The communication system and interference management module are as shown in FIG. 1A.

A specific method for BF involves performing channel estimation based on a reference signal y_{RS} to obtain the estimated channel, designing BF weights according to the estimated channel, and concentrating the UE signals onto a certain beam direction. That is, the user signals transmitted after multiplexing same time-frequency-spatial resources are separated from the spatial domain to obtain low-interference user data. When receiving through all antennas, the BF module becomes ineffective, meaning that the user signals use the same time-frequency-spatial resources and interfere with each other.

A specific method for equalization involves balancing the signals by adjusting equalizer weights, thereby eliminating the effect of signal fading and interference. The design of equalization weights depends on the channel estimation and the BF weights, e.g., compensating for the signals according to the obtained channel characteristics.

A specific method for resource coordination involves determining whether resources may be multiplexed among users according to reception performance of users, and coordinating the resources by a resource multiplexing ratio. If interference among users is large, leading to poor reception performance, the multiplexing ratio is required to be reduced, that is, sacrificing the resources to meet the performance requirements. Generally, adjustable resources include time-frequency-spatial resources and power domain resources. Through resource coordination, multiplexing UE set & allocated resources may be obtained.

Generally, the BF method depends on the accuracy and timeliness of the channel estimation, and when the channel changes, the channel estimation presents delay resulting in estimation error. Error in the channel estimation will prevent BF from effectively isolating users, introducing interference. Moreover, BF typically disregards the effect of remaining interference in final user signals, and the magnitude of interference in the final signals is difficult to estimate. The BF-processed signals are used as input to an equalizer at the receive terminal, which mitigates interference through equalization.

However, the effect of equalization is related to the design of equalization weights. Generally, the equalization weights are designed based on the channel estimation and the BF weights. Error in the channel estimation and errors in the BF weights cause errors in the equalization weights. Therefore, the signal after equalization still contains a significant amount of interference.

To further mitigate interference, a successive interference cancellation (SIC) receiver may be employed. The SIC receiver performs interference cancellation on the signals serially, but may not mitigate interference for the highest priority user, and, only mitigate partial interference for intermediate users. When signal quality difference is small, the unmitigated interference in users will be more significant. Also, the SIC receiver suffers from an error propagation issue. Consequently, the finally obtained signal still contains a significant amount of interference, resulting in an inaccurate signal where the magnitude of interference included in the signal is difficult to estimate. The AI/ML-based method typically employs single-pass AI networks to directly mitigate interference, such as CNN-based networks. However, these AI models suffer from poor interpretability, and fail to accurately capture the features of interference superposition and removal processes, resulting in poorer mitigation performance. In contrast, a diffusion model (DM) is a multi-step AI model based on state changes. It may capture the gradual change of signal distributions, offer high interpretability, and deliver better de-noising effect. The processing of the diffusion model is a multi-step iterative process:

$${x}_{t} = \sqrt{\overline{{α}_{t}}} {x}_{0} + \sqrt{1 - \overline{{α}_{t}}} ϵ , where \overline{{α}_{t}} = {\prod }_{i = 1}^{t} {α}_{i} , and {α}_{i} ∈ ( 0 , 1 )$$

is a hyperparameter. This process gradually adds noise to the original signal x₀, as shown in FIG. 1D. Then a reverse process is used to remove the noise. However, the current DM-based de-interference method only considers the characteristic of a target user. There is often a correlation among multiplexing users, and as the correlation among multiplexing users increases and the number of multiplexing users increases, the features among multiplexing users are coupled together so that they are difficult to distinguish. Depending solely on the features of a certain target user of the multiplexing users to mitigate interference will cause the mitigated interference overlapping with the useful signal, thereby significantly reducing the effect of interference mitigation.

Furthermore, performance metrics of signal, such as signal to interference plus noise ratio (SINR), throughput (Tput), modulation index (MI), etc. may be obtained based on the finally obtained interference-mitigated signal. Depending on these performance metrics, the resource coordination module may isolate users with significant mutual interference by physical resources or using smaller multiplexing coefficients. In the selection of multiplexing users, the performance of users using the same resources will be estimated, current user performance is used as the interference-free transmission performance, and the user's performance after multiplexing is obtained based on the estimated interference magnitude. However, accurate interference information cannot be obtained.

If the obtained performance metrics are generated based on inaccurate signals, poor performance may result. To ensure the performance, the resource coordination requires smaller resource multiplexing coefficients, sacrificing more resources. Furthermore, the resource coordination depends on the current performance metrics, which are related to the current multiplexing user relation. When the network channel changes, the relation between the obtained performance and the multiplexing users also changes, affecting the result of resource coordination.

In summary, the issues needed to be addressed by existing solutions include:

1) A significant amount of remaining interference remains unmitigated, leading to inaccurate final signals and poor performance.

2) The unmitigated interference is difficult to estimate, and it is impossible to obtain accurate interference information.

3) Channel estimation errors and channel changes lead to inaccurate BF design, which does not account for the effect of remaining, unmitigated interference.

4) Channel changes cause a change in performance, interference and the corresponding relation between the multiplexing users, while also changing the channel estimation. These changes lead to inaccurate basis for BF and resource coordination design, preventing the BF from effectively isolating interference, causing the resource coordination to select undesired multiplexing user pairs, and resulting in poor resource utilization.

5) The quality of signals containing a significant amount of unmitigated interference is poor, and the resource coordination will sacrifice more resources in order to ensure transmission quality.

It can be seen from the above issues that the accuracy of output signals, on one hand, determines user performance, and on the other hand, determines the accuracy of BF design and resource coordination. Furthermore, channel changes impact how effective interference, performance, and the corresponding relation between the multiplexing users is obtained and used for BF and resource coordination. However, the system interference originates from the multiplexed users. Therefore, the three modules collectively determine the performance of the overall network.

The disclosure proposes an interference management method based on an interference pattern guided diffusion model (IGDM). This solution performs interference mitigation for any one or multiple users among paired users using the diffusion model based on MU pairing pattern (pairing information), the estimated channel of MU-paired users, and MCS (or modulation information or information representative of signal intensity). Additionally, to meet real-time interference mitigation requirements, a multiple-state diffusion processing method is designed to enhance the robustness of the diffusion model and make adaptive DM model size decisions according to communication environment and anti-interference requirements. The overall framework of the solution is as shown in FIG. 1E.

Firstly, interference-related information (e.g., interference pattern) for the current user is obtained based on the pairing information, channel information, and signal intensity information of multiplexing users, and the interference-related information is input as a condition into the diffusion model, as a condition for the de-interference diffusion model. Meanwhile, interference diffusion weights are proposed, and the interference diffusion model is designed based on the interference diffusion weights. Under this conditional guidance, the interference diffusion model is utilized to perform the interference mitigation method. This process may mitigate interference in the received signal, obtaining an accurate signal while also determining the magnitude of interference. Each step of the diffusion model is performed on the basis of weighted values of cosine similarity of multiple historical states. This accounts for the effect of multiple historical processing steps, reducing jitter in the diffusion process and enhancing the robustness. Furthermore, the model size may be determined based on environmental information and specific anti-interference requirements of the user. An appropriate model size is used for different environments and requirements to mitigate interference, improving the effectiveness of the model.

Secondly, according to the accurate information and interference magnitude after interference mitigation, a mutual interference effect graph (which may be also described as a mutual interference graph, which may correspond to the first user equipment relation in the embodiments of the disclosure) based on matching channel feature indexes is designed to obtain interference, performance, and multiplexing user relation matching the current channel state, and to resolve invalid information caused by channel changes.

Finally, according to the matched mutual interference graph, the design selects users for multiplexing that optimize network performance. Meanwhile, an interference-aware BF is designed for the selected multiplexing users according to the interference magnitude and performance in the graph.

The disclosure may achieve the following beneficial effects:

1) Interference in the received signal of the current communication system is mitigated, and signal quality and system performance are improved.

2) By combining inputs/outputs of interference mitigation process with the diffusion model, the interference magnitude may be obtained (sensed), interference values are provided for the process of other interference-based modules.

3) The model size is determined according to different environments and user requirements. The processing is simplified in simple environments and low-demand scenarios to enhance the applicability and effectiveness of the model.

4) Consider the effect of multiple historical states according to signal cosine similarity features to reduce the fluctuation in multi-step processing of the diffusion model and enhance the robustness.

5) Through interference mitigation and matching graph, it is possible to obtain an accurate performance, interference, and corresponding relation between multiplexing users of the user that match channel changes. Meanwhile, the channel feature indexes are utilized to record channel changes, reducing memory consumption caused by historical information due to channel changes.

6) For different multiplexing user performance and interference, based on the matched interference effect graph, resource coordination strategies for multiplexing users that optimize performance may be designed, thereby enhancing system performance.

7) Designing the BF weights in combination with the sensed interference enables further interference mitigation, enhancing system performance.

The technical solutions of the embodiments of the disclosure and the technical effects produced by the technical solutions of the disclosure are described below by describing several optional embodiments. It should be noted that the following embodiments may be referred to, learned from, or combined with each other, and the same terms, similar features, and similar implementation steps/operations in different embodiments will not be described repeatedly.

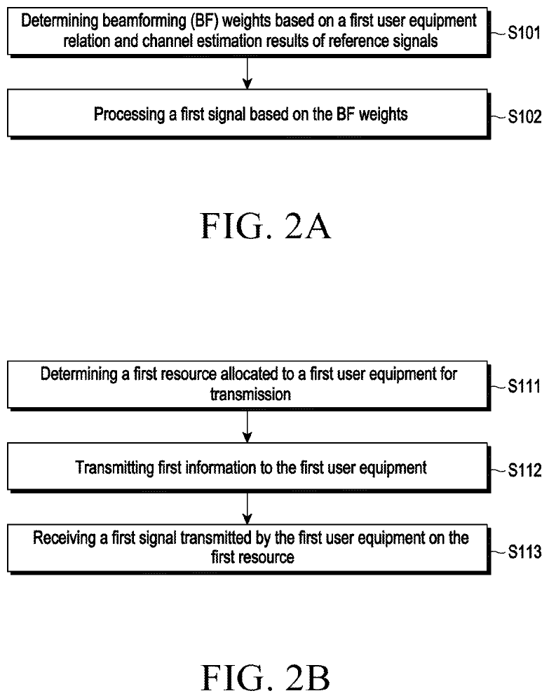

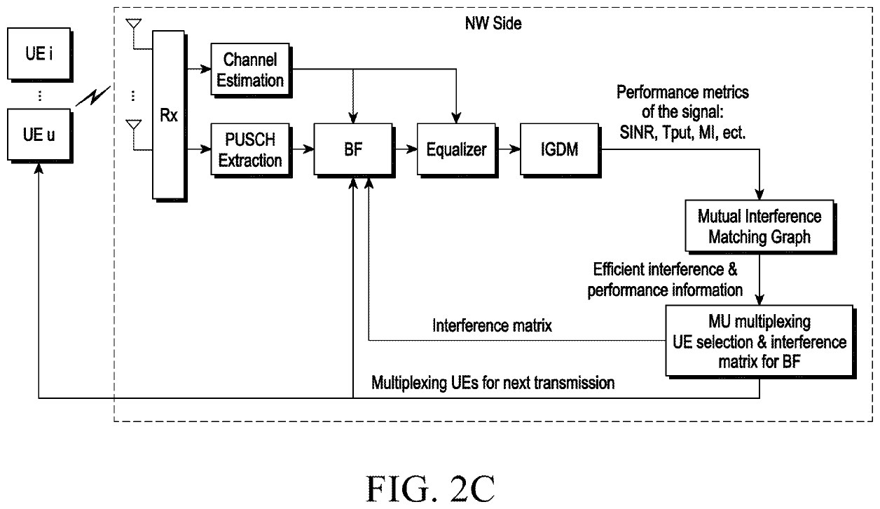

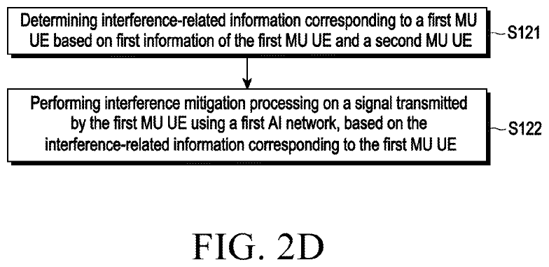

FIG. 2A illustrates a schematic flow diagram of a method performed by a network node according to an embodiment of the disclosure. Referring to FIG. 2A, the method may comprise:

Operation S101. Determining beamforming (BF) weights based on a first user equipment relation and channel estimation results of reference signals.

Optionally, the first user equipment relation is constructed based on a resource multiplexing relation among multiple user equipments and channel feature indexes of respective user equipments.

Optionally, the first user equipment relation may include performances of respective multiplexing user equipments and interference magnitude when performing resource multiplexing.

In some embodiments, a network node may construct the first user equipment relation, which may be in the form of a graph (e.g., described as a mutual interference graph or a mutual interference effect graph). It should be noted that the terms of mutual interference graph and mutual interference effect graph hereinafter may be understood as the above-described first user equipment relation.

In some embodiments, the process of constructing a mutual interference graph may comprise:
constructing a relation graph of interference-multiplexing users based on a user multiplexing relation; and
expanding each node in the relation graph into a multi-performance node to obtain the mutual interference graph,
wherein each performance node is connected with one performance node of other user, meaning respective performance of the two users when multiplexing, and the weight of a line connected between the two performance nodes is the interference magnitude when multiplexing.

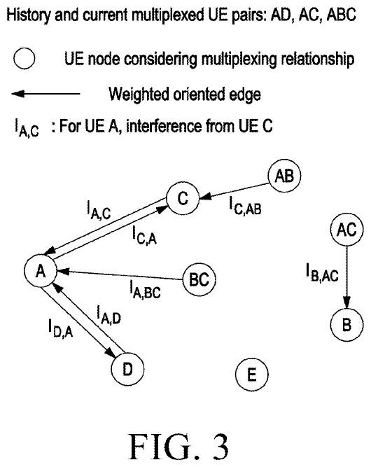

FIG. 3 is a schematic diagram of an interference-multiplexing user relation graph according to an embodiment of the disclosure.

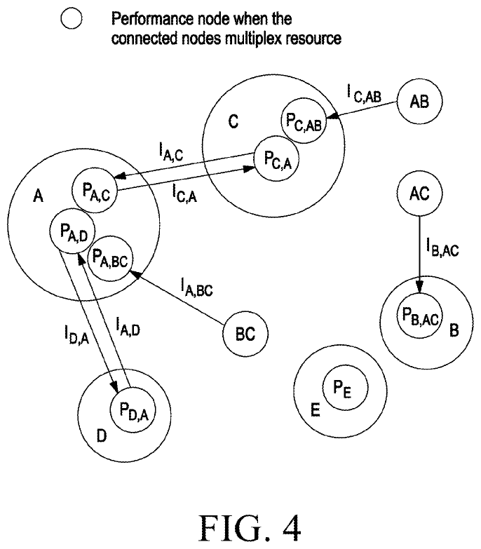

FIG. 4 is a schematic diagram of another interference-multiplexing user relation graph according to an embodiment of the disclosure.

In some embodiments, a network device may obtain historical and current user multiplexing information, and performance metrics such as channel features, interference, and signal reception quality of users when pairing, to construct the interference-multiplexing user relation graph, as shown in FIG. 3. Then, considering that a same user multiplexes resources with multiple different users during scheduling, and that the user performance varies under different multiplexing relations, the above-described interference-multiplexing user relation graph is expanded into a multi-node graph, e.g., a multi-node performance and interference-multiplexing user relation graph (e.g., the mutual interference effect graph), as shown in FIG. 4.

In some embodiments, after expanding each node in the relation graph into multi-performance node, the method further comprises:
optimizing the relation graph based on the user's channel feature index; and
expanding the optimized relation graph according to a relation between different multiplexing user sets in the optimized relation graph, to obtain the mutual interference graph.

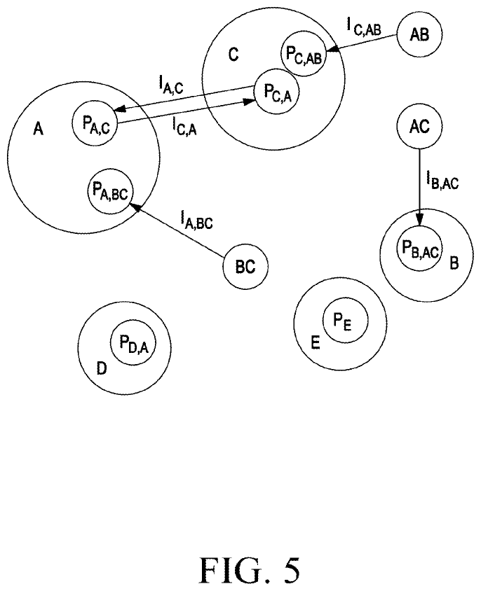

FIG. 5 is a schematic diagram of a mutual interference effect graph based on matched channel feature indexes according to an embodiment of the disclosure.

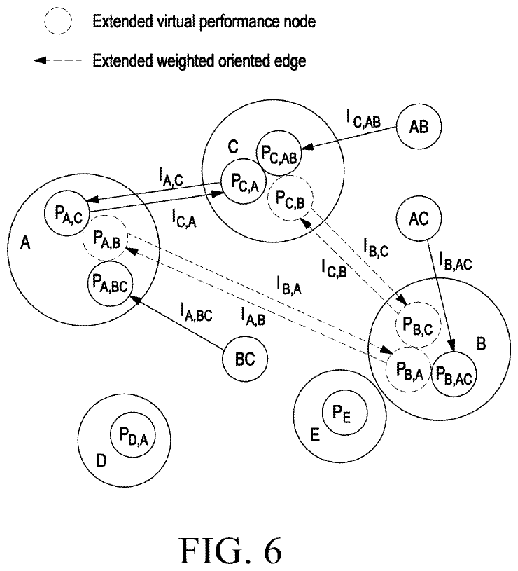

FIG. 6 is a schematic diagram of an extended mutual interference effect graph according to an embodiment of the disclosure.

In some embodiments, considering that the multiplexing information, performance, and interference are historical information, when a user's channel undergoes a larger change, some historical multiplexing information and corresponding performance/interference become outdated and unusable. Therefore, it is necessary to optimize the multi-node relation graph based on the user's channel feature index. For example, nodes where the current channel index is not consistent with the corresponding channel index in the graph are deleted, as shown in FIG. 5.

In some embodiments, the optimized multi-node relation graph may be further expanded, e.g., based on the relation between different multiplexing user sets, to obtain the mutual interference graph, as shown in FIG. 6.

In the above embodiments, the specific process for constructing the mutual interference graph may refer to relevant content of “Constructing Mutual Interference Effect Graph based on Matched Channel Feature Indexes” described below in connection with FIG. 2C.

In some embodiments, the operation S101 may specifically comprise:
determining the BF weights based on a first BF weight and the interference magnitude related to the first user equipment in the first user equipment relation, wherein the first BF weight is determined based on a feature matrix obtained by performing channel estimation on the reference signal; or
determining the BF weights based on direction of a second BF weight and the interference magnitude related to the first user equipment in the first user equipment relation, wherein the second BF weight is a combined weight obtained by performing channel estimation on the reference signal.

In this embodiment, the specific implementation process for determining BF weights based on the first user equipment relation may refer to relevant content of “Methods 1 & 2 for BF Design Based on Mutual Interference Effect Graph” described below in connection with FIG. 2C.

Operation S102. Processing first signal based on the BF weights.

Optionally, the first signal is a signal received from the first user equipment or a signal transmitted to the first user equipment.

In some embodiments, the network node may perform BF processing on the received first signal by using the BF weights determined above to.

In some embodiments, the network node may perform BF processing on the first signal to be transmitted by using the BF weights determined above.

In some embodiments, the network node receives the first signal transmitted by the first user equipment, and inputs the first signal into a first artificial intelligence (AI) model to perform interference sensing and mitigation.

Optionally, the first AI model is an interference channel diffusion model trained based on a de-interference and de-noising diffusion model.

In some embodiments, a network device may perform interference sensing and mitigation on the received signal based on the interference channel diffusion model trained using the de-interference and de-noising diffusion model, thereby achieving better interference management.

In some embodiments, the training process for the interference channel diffusion model may comprise:
obtaining the de-interference and de-noising diffusion model and training sets, wherein the training sets comprise a set of sample signals, a set of number of steps/operations for noise addition, and model parameters; and
performing training operation repeatedly on the de-interference and de-noising diffusion model based on the training sets, until training termination condition is satisfied, to obtain the trained first AI model, wherein the training operations comprise:
randomly selecting first sample signal from the set of sample signals and a first number of steps/operations from the set of number of steps/operations for noise addition; obtaining a channel of the first sample signal, and calculating corresponding channel matrix, interference weight, and noise weight for corresponding real-valued signal; randomly sampling to obtain a distribution corresponding to weighted interference and/or weighted noise, and obtaining a predicted interference distribution and/or predicted noise distribution corresponding to the first sample signal by using the de-interference and de-noising diffusion model; and
determining a training loss based on an actual interference distribution and the predicted interference distribution, and/or an actual noise distribution and the predicted noise distribution corresponding to the first sample signal,
wherein the training termination condition may include the training loss being less than a preset value.

In this embodiment, the training process regarding the interference channel diffusion model may refer to relevant content of “Design Interference Channel Diffusion Model” and “Modeling Process” described below in connection with FIG. 2C.

In some embodiments, the method may further comprise:
transmitting first information including a first resource to the first user equipment, wherein the first resource is a resource allocated by the network device to the first user equipment for transmission;
receiving, by the network node, the first signal transmitted by the first user equipment on the first resource, or transmitting the first signal to the first user equipment on the first resource.

In some embodiments, the method may further comprise:
determining the first resource allocated to the first user equipment based on the first user equipment relation.

In this embodiment, the network device may notify the user equipment of the first resource which is allocated to the user equipment after resource coordination, in order for the user equipment to transmit and/or receive signal on the first resource, thereby avoiding signal interference.

In some embodiments, the resource coordination may be implemented using existing solutions, which are not described in detail herein.

It should be noted that the resource coordination in the embodiments of the disclosure may be understood as determining, based on the objective of the resource coordination, resources allocated to each user equipment having a resource multiplexing relation for transmission in case that the performance metrics of the signal satisfy constraints and determining a multiplexing user set to which each user equipment belongs.

In some embodiments, the resource coordination may be performed based on the mutual interference graph. Optionally, the network device may perform the resource coordination based on information such as the performance (e.g. the performance metric (e.g., SINR, TPUT, SE etc.)) and interference magnitude of each user in the mutual interference graph, thereby making the result of the resource coordination optimal.

In some embodiments, the network device may determine whether the information in the mutual interference graph is available based on current channel information of the terminal. For available information, the resource coordination is performed based on the mutual interference graph, but for unavailable information, the resource coordination is performed based on existing methods.

In some embodiments, the performing the resource coordination based on the mutual interference graph may comprise:
obtaining the performance of the first user equipment when multiplexing resource with other user equipments, according to resource multiplexing information of the first user equipment relation; and
determining the result of the resource coordination based on metric of the performance meeting a first constraint, wherein the result of the resource coordination may include the resource allocated to each user equipment for transmission.

Optionally, the result of the resource coordination may further include a multiplexing user set to which each user equipment belongs.

Optionally, the first constraint may be a condition that optimizes the performance of each user equipment when transmitting signal on the resources allocated thereto.

In this embodiment, the specific implementation process of performing the resource coordination based on the mutual interference graph may refer to relevant content of “Perform Resource Coordination Based on Mutual Interference Effect Graph” described below in connection with FIG. 2C.

In some embodiments, the resource coordination may also be performed based on interference mitigation effectiveness. Optionally, the network device may perform the resource coordination based on interference mitigation parameters used to estimate the interference mitigation effectiveness (e.g., described as interference mitigation parameters). Optionally, the interference mitigation parameters may be a ratio between a signal after interference mitigation and a signal before interference mitigation. Optionally, the interference mitigation parameters may be used to calculate the magnitude of interference that is unmitigated.

In some embodiments, the first resource allocated to the first user equipment is determined based on the obtained magnitude of interference experienced by the first user equipment, the estimated interference mitigation parameters, and the performance metrics of the first user equipment.

In some embodiments, the interference mitigation parameters may be determined based on a first error and a second error. Optionally, the first error may be an error between output signal of the first AI model and second signal, and the second error may be an error between the input signal of the first AI model and the second signal, wherein the second signal may be understood as an ideal data signal input to the first AI model.

Optionally, the interference mitigation parameters may be a ratio of the first error to the second error.

In this embodiment, the specific implementation process of performing the resource coordination based on the interference mitigation effectiveness may refer to relevant content of “Another Resource Coordination Method” described below in connection with FIG. 2C.

In some embodiments, the operation S102 may comprise preprocessing the first signal and inputting into the first AI model.

Optionally, the preprocessing may include beamforming (BF) processing, or the preprocessing may include BF processing and equalization processing, or the preprocessing may include BF processing, equalization processing, and serial interference cancellation (SIC) processing.

In some embodiments, after receiving a signal transmitted by a terminal, the network device may firstly preprocess the signal and then input the preprocessed signal into the first AI model.

Optionally, after receiving a signal transmitted by a terminal, the network device may input the signal into a BF module for processing, then input into the first AI model.

Optionally, after receiving a signal transmitted by a terminal, the network device may input the signal into a BF module for processing, then input into an equalizer (or equalization module) for processing, and finally input into the first AI model.

Optionally, after receiving a signal transmitted by a terminal, the network device may input the signal into a BF module for processing, then input into an equalizer (or equalization module) for processing, then input into an SIC receiver for processing, and finally input into the first AI model.

In some embodiments, the processing method of the BF mode may be implemented using existing solutions, which are not described in detail herein.

In some embodiments, the BF weights used in the BF processing are determined based on the mutual interference graph. Optionally, the network device may obtain new BF weights based on information such as the performance (e.g. the performance metrics (e.g., SINR, TPUT, SE, etc.)) and interference magnitude of each user in the mutual interference graph, as well as current BF weights; and perform BF processing by using the new BF weights when receiving signal.

In some embodiments, a method for determining the new BF weights comprises any one of the following methods.

Method 1: Determining the new BF weights based on a first BF weight and the interference magnitude related to the terminal in the mutual interference graph. Herein, the first BF weight is determined based on a feature matrix obtained by channel estimation of the first signal. The first BF weight may be understood as current BF weights.

In this embodiment, the specific implementation process for determining the BF weights based on the mutual interference graph may refer to relevant content of “Method 1 for BF Design based on Mutual Interference Effect Graph” described below in connection with FIG. 2C.

Method 2: Determining the new BF weights based on the direction of a second BF weight and the interference magnitude related to the terminal in the mutual interference graph, wherein the second BF weight is a combined weight obtained by channel estimation of the first signal. The second BF weight may be understood as current BF weights, used to characterize the beam direction.

In this embodiment, the specific implementation process for determining the BF weights based on the mutual interference graph may refer to relevant content of “Method 2 for BF Design Based on Mutual Interference Effect Graph” described below in connection with FIG. 2C.

FIG. 2B illustrates a schematic flow diagram of a method performed by a network node according to an embodiment of the disclosure. Referring to FIG. 2B, the method may comprise:

Operation S111. Determining a first resource allocated to a first user equipment for transmission.

Optionally, the first resource is determined based on a first user equipment relation, the first user equipment relation being constructed based on a resource multiplexing relation among multiple user equipments and channel feature indexes of respective user equipments.

In some embodiments, the first user equipment relation may include performances of respective multiplexing user equipments and interference magnitude when performing resource multiplexing.

In some embodiments, the operation S111 may comprise: determining the first resource allocated to the first user equipment based on the first user equipment relation.

Optionally, the determining the first resource may comprise: obtaining the performance of the first user equipment when performing resource multiplexing with other user equipment(s), according to resource multiplexing information of the first user equipment relation; and
determining the resources allocated to respective user equipments for transmission based on metric of the performance meeting a first constraint.

In this embodiment, the specific implementation process for determining the first resource allocated to the first user equipment based on the first user equipment relation may refer to relevant description hereinabove, or may also refer to relevant content of “Perform Resource Coordination Based on Mutual Interference Effect Graph” described below in connection with FIG. 2C.

Optionally, the first resource is determined based on the obtained magnitude of interference experienced by the first user equipment, the estimated interference mitigation parameters, and the performance metrics of the first user equipment.

In some embodiments, the operation S111 may comprise: determining the first resource allocated to the first user equipment based on the obtained magnitude of interference experienced by the first user equipment, the estimated interference mitigation parameters, and performance metrics of the first user equipment.

Optionally, determining magnitude of unmitigated interference based on the magnitude of interference experienced by the first user equipment and the interference mitigation parameters; and
determining the first resource allocated to the first user equipment based on the performance metrics of the first user equipment and the magnitude of unmitigated interference meeting the condition.

In this embodiment, the specific implementation process for determining the first resource by performing the resource coordination based on the interference mitigation parameters may refer to relevant description hereinabove, or may also refer to relevant content of “Another Resource Coordination Method” described below in connection with FIG. 2C.

Operation S112. Transmitting first information to the first user equipment, wherein the first information may include the first resource.

In some embodiments, after determining the first resource allocated to the first user equipment, the network node may notify the first user equipment of the first resource in order for the first user equipment to receive and/or transmit signal on the first resource.

Operation S113. Receiving a first signal transmitted by the first user equipment on the first resource, or transmitting the first signal to the first user equipment on the first resource.

In some embodiments, the method may further comprise:
determining beamforming (BF) weights based on the first user equipment relation and the channel estimation results of reference signals; and
processing the first signal based on the BF weights.

In some embodiments, the network node may also determine, based on the first user equipment relation, the BF weights used when performing BF processing on the signal.

In this embodiment, the specific implementation process for determining the BF weights may refer to relevant description of the operation S101 hereinabove.

In the above embodiments, the network device may construct the first user equipment relation. It should be noted that the implementation process for constructing the first user equipment relation may refer to relevant content of “Construct Mutual Interference Effect Graph Based on Matched Channel Feature Indexes” described below in connection with FIGS. 2C and 3 to 6.

In some embodiments, the determining BF weights based on the first user equipment relation and the channel estimation results of reference signals, comprises:
determining the BF weights based on a first BF weight and the interference magnitude related to the first user equipment in the first user equipment relation, wherein the first BF weight is determined based on a feature matrix obtained by performing channel estimation on the reference signal; or
determining the BF weights based on the direction of a second BF weight and the interference magnitude related to the first user equipment in the first user equipment relation, wherein the second BF weight is a combined weight obtained by performing channel estimation on the reference signal.

In this embodiment, the specific implementation process for determining BF weights based on the mutual interference graph may refer to relevant content of “Method 2 for BF Design Based on Mutual Interference Effect Graph” described below in connection with FIG. 2C.

In some embodiments, the network node may determine a first AI model and transmit the first AI model to a terminal. The first AI model is used for performing interference sensing and mitigation on the input signal.

Optionally, the first AI model is an interference channel diffusion model trained based on a de-interference and de-noising diffusion model.

In some embodiments, the process of the network node determining the first AI model may refer to relevant content of “Design Interference Channel Diffusion Model” and “Modeling Process” described below in connection with FIG. 2C.

In some embodiments, after training the interference channel diffusion model, the network node may transmit the model to the first user equipment, in order for the first user equipment to use the model for performing interference sensing and mitigation on the received signal.

In some embodiments, the method may further comprise:
receiving second information transmitted by the first user equipment, wherein the second information may include performance and interference magnitude obtained by the first user equipment running the first AI model;
wherein the network node may construct a mutual interference graph based on the second information.

In some embodiments, after receiving the interference channel diffusion model transmitted by the network node, the first user equipment runs the model to perform interference sensing and mitigation on the received signal, obtains information such as performance and interference magnitude and feeds it back to the network node. The network node may construct the mutual interference graph based on the information fed back by the first user equipment.

In some embodiments, the process for constructing the mutual interference graph by the network node may refer to relevant content of “Constructing Mutual Interference Effect Graph Based on Matched Channel Feature Indexes” described below in connection with FIG. 2C.

In some embodiments, the network node may transmit the first signal to the first user equipment on the first resource allocated to the first user equipment based on the mutual interference graph.

In some embodiments, the transmitting the first signal to the first user equipment on the first resource, comprises:
transmitting the first signal on the first resource after performing BF processing on the first signal;
wherein, the BF weights used in the BF processing are determined based on the mutual interference graph.

In some embodiments, the network node may perform BF processing on the signal to be transmitted to the user equipment, and then transmit it on the resource determined based on resource coordination.

In this embodiment, the specific implementation process for determining BF weights based on the mutual interference graph may refer to relevant content of “Methods 1 & 2 for BF Design Based on Mutual Interference Effect Graph” described below in connection with FIG. 2C.

In some embodiments, the first user equipment may also perform the following operations:
receiving a first AI model transmitted by the network node, wherein the first AI model is an interference channel diffusion model trained based on a de-interference and de-noising diffusion model; and
inputting the first signal from the network node into the first AI model for interference sensing and mitigation.

In some embodiments, the first user equipment may receive the interference channel diffusion model transmitted by the network node, to run the model for performing interference sensing and mitigation on the received signals.

In some embodiments, the method may further comprise:
Obtaining performance and interference magnitude of the first user equipment; and
transmitting second information to the network device, wherein the second information may include the performance and interference magnitude of the first user equipment, and the second information is used to construct the mutual interference graph.

In some embodiments, after receiving the interference channel diffusion model transmitted by the network device, the first user equipment runs the model to perform interference sensing and mitigation on the received signal, obtains information such as performance and interference magnitude and feeds it back to the network node, in order for the network node to construct the mutual interference graph based on the information fed back by the first user equipment.

In some embodiments, the method may further comprise:
receiving the first signal transmitted by the network node on the first resource, wherein the first resource is determined through resource coordination based on the mutual interference graph.

In some embodiments, the first user equipment may receive the signal transmitted by the network node on the first resource determined based on resource coordination.

In some embodiments, the network node may determine resource for transmitting the signal to the first user equipment by performing resource coordination based on the mutual interference graph. Optionally, after determining the first resource, the network node may notify the terminal so that the terminal may receive, on the first resource, the signal transmitted by the network node.

In some embodiments, the process for performing resource coordination based on the mutual interference graph by the network device may refer to relevant content of “Perform Resource Coordination Based on Mutual Interference Effect Graph” described below in connection with FIG. 2C.

In some embodiments, the above method may further comprise: the first signal being BF-processed signal, wherein the BF weights used in the BF processing are determined based on the mutual interference graph.

In some embodiments, the network node may transmit the signal after performing the BF processing. Optionally, the BF weights used when performing the BF processing on the signal by the network node may be determined based on the mutual interference graph.

In this embodiment, the specific implementation process for determining BF weights based on the mutual interference graph may refer to relevant content of “Methods 1 & 2 for BF Design Based on Mutual Interference Effect Graph” described below in connection with FIG. 2C.

It should be noted that in the above embodiments, the interference management methods provided by the embodiments of the disclosure may be applied to one network node, or to multiple network nodes simultaneously, or to both network node and user equipment.

FIG. 2D illustrates a schematic flow diagram of a method performed by a network node according to an embodiment of the disclosure. Referring to FIG. 2D, the method may comprise:

Operation S121: Determining interference-related information corresponding to a first MU UE based on first information of the first MU UE and a second MU UE.

Optionally, the second MU UE and the first MU UE perform MU MIMO transmission.

Optionally, the first information may include at least one of: MU pairing information, signal intensity-related information, and channel-related information.

Operation S122. Performing interference mitigation processing on a signal transmitted by the first MU UE using a first neural network, based on the interference-related information corresponding to the first MU UE.

In some embodiments, the interference-related information corresponding to the first MU UE may include interference weight information and/or interference channel information.

Optionally, the interference weight information indicates interference intensity from the second MU UE to the first MU UE on each frequency-domain resource.

Optionally, the interference channel information indicates an interference channel from the second MU UE to the first MU UE on each frequency-domain resource.

In some embodiments, the operation S121 may comprise:
determining the interference weight information corresponding to the first MU UE based on the MU pairing information and the signal intensity-related information; and/or
determining the interference channel information corresponding to the first MU UE based on the MU pairing information and the channel-related information.

In some embodiments, the operation S122 may comprise:
determining a number of processing steps for interference mitigation by the diffusion network; and
using the interference-related information corresponding to the first MU UE as constraint for the diffusion network, and performing the interference mitigation processing on the signal transmitted by the first MU UE using the first neural network, based on the determined number of processing steps.

In some embodiments, the determining the number of processing steps for interference mitigation by the diffusion network, comprises:
determining a maximum number of steps for interference mitigation by the diffusion network using a second neural network based on environmental information of the first MU UE; and
determining the number of processing steps for interference mitigation by the diffusion network based on the maximum number of steps and the signal intensity-related information of the first MU UE.

In some embodiments, the performing interference mitigation processing on the signal transmitted by the first MU UE using the first neural network, comprises:
using the interference-related information corresponding to the first MU UE as constraint for the diffusion network, iteratively performing T times of the interference mitigation processing, wherein T is the determined number of processing steps,
wherein t-th interference mitigation processing in the T times of interference mitigation processing comprises:
determining required historical interference mitigation processing results;
weighting the historical interference mitigation processing results, and using the weighted results as a result of (t−1)-th interference mitigation processing;
predicting interference for the first MU UE based on the result of the (t−1)-th interference mitigation processing and the interference-related information corresponding to the first MU UE; and
performing the t-th interference mitigation processing based on the predicted interference.

In the above embodiments, the signal intensity-related information may include a modulation and coding scheme (MCS) and/or a signal to interference plus noise ratio (SINR), and the channel-related information may include the channel estimation results of the UEs.

For interference issues, an embodiment of the disclosure proposes an interference management system (or device) and a method based on an interference pattern guided diffusion model.

FIG. 2C illustrates the interference management system based on the interference channel diffusion model according to an embodiment of the disclosure.

The interference management method provided by the embodiment of the disclosure is applicable to interference management for multi-user multiplexing within the same cell coverage area and user resource multiplexing between different cells.

A solution of the embodiment of the disclosure may include the following four parts: an IGDM module for interference mitigation and sensing; the generation of a mutual interference effect graph based on matched channel feature indexes; resource coordination based on the graph or interference mitigation effectiveness; and BF design based on the graph.

The network side constructs the mutual interference effect graph based on information such as performance (SINR, TPUT, spectral efficiency (SE), mutual information (MI), etc.), interference, and historical pairing information, channel features of users when pairing, and currently obtained user channel feature of each UE. The pairing relation of the user under the current channel feature, along with the performance and interference when pairing, are represented through a graph, e.g., the mutual interference effect graph.

According to the mutual interference effect graph, the network side selects users with optimal target to multiplex the same resources. These multiplexing users form one or more multiplexing user sets, each containing one or more multiplexing users.

The network side distributes the resources used by the multiplexing users to the UE side. The UE side transmits data to the network side on the received resources.

The network side designs the BF weights based on the channel estimation results and interference information obtained from the interference graph. The network side processes the received data signal through the BF module, with the output signal serving as input to the equalizer.

The signal output from the equalizer or SIC is finally input into the IGDM module for final remaining interference mitigation and sensing. The IGDM module may mitigate noise and interference through diffusion processing while simultaneously obtaining the magnitude of interference.

The IGDM module may be placed after existing processing modules in the current system, as shown in the figure. Alternatively, each of the existing BF/equalization/SIC modules may be fully or partially replaced by the IGDM (e.g., replacing only SIC, only equalization, or both equalization and SIC, etc.).

The module of resource coordination based on the graph and the module of BF design based on the graph are optional. They may not be used or may be used simultaneously, or one module of them is used. A method corresponding to one module when not used adopts a conventional method.

Several parts included in the interference management system disclosed in the embodiments of the disclosure are described in detail below, respectively.

### I: Construct Mutual Interference Effect Graph Based on Matched Channel Feature Indexes (e.g., Generation of Mutual Interference Effect Graph Based on Matched Channel Feature Indexes).

Historical and current user multiplexing information, along with performance metrics such as channel features, interference, and signal reception quality when pairing are obtained (Tput, MI, etc., may be used to determine user performance metrics after multiplexing the resource next time).

Firstly, an interference-multiplexing user relation graph based on multiplexing relation of the user is constructed, as shown in FIG. 3.

The interference-multiplexing graph is represented by a weighted directed graph. Nodes in the graph represent users or multiplexing user pairs, and an edge between two nodes indicates that users in the two nodes performed resource multiplexing. Weight of the edge reflects the interference magnitude, and a direction of the edge indicates interference from a start node to an end node.

Considering that a same user multiplexes resources with multiple different users during scheduling, and that the user performance varies under different multiplexing relations. Thus, the above-described interference-multiplexing user relation graph is expanded into a multi-node graph, e.g., a multi-node performance and interference-multiplexing user relation graph (e.g., the mutual interference effect graph). The multi-node performance and interference-multiplexing user relation graph (as shown in FIG. 4) represents a graph of performances and interference magnitudes of the user obtained under different multiplexing relations and interference conditions.

In the mutual interference effect graph, each user node is expanded into a multi-performance node, wherein each performance node is connected with one performance node of other user, meaning respective performance of the two users when multiplexing, and the weight of the edge is interference magnitude when multiplexing.

Since the multiplexing information, performance, and interference are historical information, when a user's channel undergoes a larger change, some historical multiplexing information and corresponding performance and interference become outdated and unusable. To obtain valid information, the channel features of each user when multiplexing each time are recorded.

The channel features are represented using channel feature indexes to reduce the space occupied by the channel features. The channel features may be obtained by analyzing the channel's spectral characteristics, including spectral amplitude, committed information rate (CIR), phase, Doppler spread, spectral periodicity distribution, and the like.

Each characteristic corresponds to an index. Optionally, the magnitudes of spectral characteristics are in one-to-one correspondence with indexes (e.g., a correspondence table of characteristic values and indexes). Subsequently, each time, spectral characteristic value is compared with spectral magnitude value in the table and remapped to an index. One index corresponds to one spectral value magnitude. The varying interval between spectral values corresponding to each index may be set to d. The spectral value may be, for example, spectral amplitude (with each spectral characteristic independently exists arrangement and combination). After amplitude normalization, e.g., the amplitude value 0 corresponds to index0, the amplitude value 0.1 corresponds to index1, and so on.

Different index values are determined by the magnitude of changes in the final user's channel characteristics. When the magnitude of changes exceeds a certain threshold, the index changes to another value.

Optionally, the current spectral characteristic only adopts amplitude, for example, an amplitude value of 0.3. According to the change interval d for the spectral value corresponding to each index in the correspondence table of indexes and characteristic values, it is possible to determine whether the change between the current amplitude (0.3) and the previous amplitude (e.g., 0.2) exceeds the change interval d. If exceeded, it indicates a significant channel change, causing the index to change from one corresponding to the amplitude of 0.2 to one corresponding to the amplitude of 0.3.

Spectral characteristic analysis is performed on the last received user estimated channel and the result is mapped to an index. A match with a corresponding index in the mutual interference effect graph is performed. If the index values do not match, the edge corresponding to the multiplexing relation and the performance node after multiplexing are deleted from the graph. If a certain user had only one performance node before deletion, that performance node is retained. The matched graph is the mutual interference effect graph based on matched channel feature indexes (as shown in FIG. 5).

Considering that the mutual interference effect graph only may include the performance of multiplexed users. For un-multiplexed users, the performance thereof after multiplexing may be only estimated during multiplexing resource allocation (e.g., if a user is multiplexed, an offset is subtracted from current performance). To obtain more valid performance-interference-multiplexing users relation information, the mutual interference effect graph is expanded. Based on the relation between different multiplexing user sets in the graph, if a certain multiplexing user set S1 is a subset of another multiplexing user set S2, and S2=S1 U S3, the interference and performance magnitude when users in S3 multiplexing with users in S1 may be obtained through algebraic operations. The final mutual interference effect graph containing more valid information is obtained (as shown in FIG. 6).

### II: Resource Coordination Based on Mutual Interference Effect Graph

The resource coordination is performed based on the mutual interference effect graph. That is, performance (performance metrics such as SINR, TPUT, SE, etc.) when a user multiplexes resources with a certain user or several users are obtained based on the case of multiplexing in the constructed graph. For unpaired users (e.g., User D and User E in FIG. 6) without corresponding performance data, it is assumed that the performance after pairing would degrade by N compared to the current performance.

It should be noted that N may be understood as the effect caused by interference. The size of N may be an estimated value, such as 2 dB, or an interference magnitude predicted based on the existing solution.

The objective of resource coordination is:
P: optimized performance
   s.t. limitation(s)

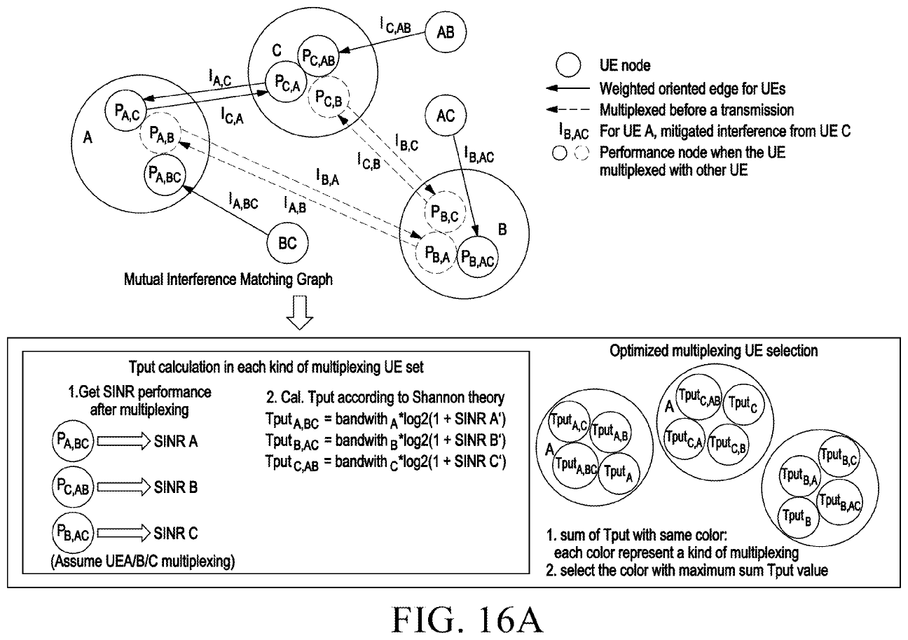

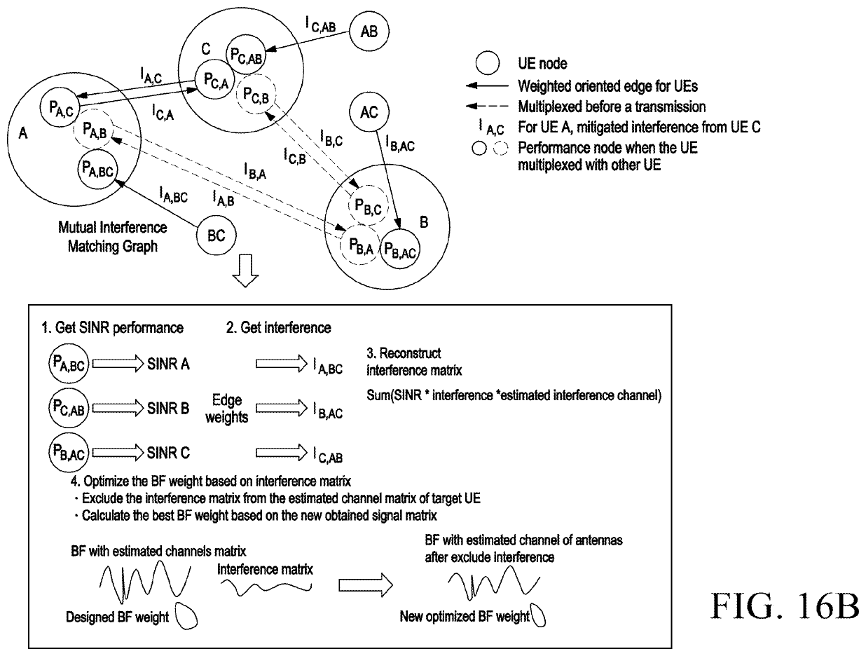

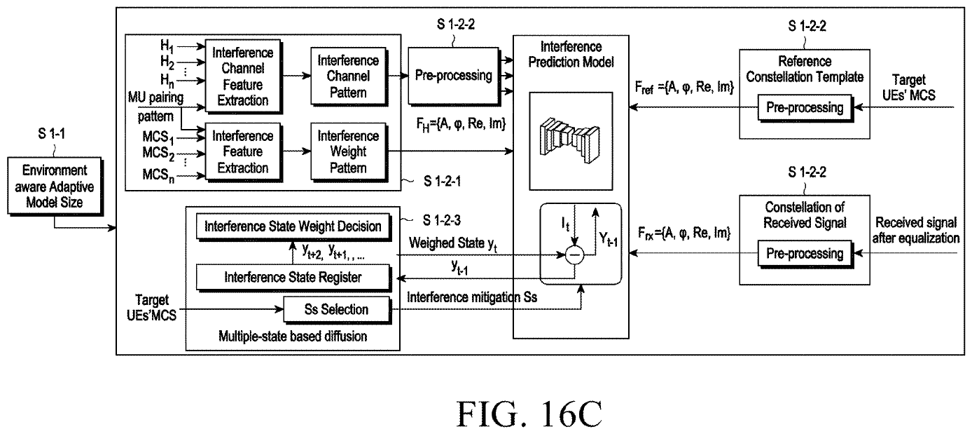

The resource coordination is established as an optimization problem to achieve an optimal performance metric (e.g., best TPUT) under constraint (which may correspond to the first constraint hereinabove). The optimization objective P is designed as an available metric for communication such as SINR, Tput, SE, or MI, and the like. The constraint (limitation) is an arbitrary one or more existing constraint in networks, such as resource utilization, QoS achieving a specified level etc., or computational method constraint that should be satisfied user's correlation and/or other evaluation metrics of network, and/or a certain metric. The process for resource coordination mainly involves obtaining interference performance and channel-related information based on the interference graph, and selecting a pairing configuration that maximizes the objective as the final resource coordination result, as shown in FIG. 16A.

FIG. 16A is a schematic diagram of a resource coordination process according to an embodiment of the disclosure.

Optionally, the correlation characterizes a degree of correlation or similarity between user channels at different positions, and high similarity indicates greater interference. However, the correlation may only characterize a linear similarity, while the channels often exhibit nonlinear relations. Therefore, Jensen-Shannon divergence (JSD) is introduced to evaluate the channel similarity among users at different spatial locations in communication. The JSD calculation formula for the channel of User m and the channel of User n is:

$$JSD = \frac{1}{2} \sum {H}_{m} ( t ) log \frac{{H}_{m} ( t )}{{H}_{m} ( t ) + {H}_{n} ( t )} + \frac{1}{2} \sum {H}_{n} ( t ) log \frac{{H}_{n} ( t )}{{H}_{n} ( t ) + {H}_{m} ( t )}$$

The JSD may be used as a constraint for resource coordination, where a smaller JSD indicates a higher similarity between two channels. The optimization problem of resource coordination obtains the result through the existing optimization method (e.g., greedy algorithms). The output result is multiplexing user sets & allocated resources.

In the JSD calculation, the original channel matrices of User m and User n may also be transformed into amplitude matrices Aₘ, Aₙ and phase matrices φₘ, φₙ, and then two-dimensional kernel estimation (2D-KDE) is performed on the amplitude matrices and the phase matrices, to separately estimate a joint probability distribution of the original amplitudes and phases. The formula is:

$$f ( A , ϕ ) = \frac{1}{n} {{\sum }_{i = 1}}^{n} \frac{1}{{h}_{A} {h}_{ϕ}} K ( \frac{A - {A}_{i}}{{h}_{A}} , \frac{ϕ - {ϕ}_{i}}{{h}_{ϕ}} )$$

$$where K ( \frac{A - {A}_{i}}{{h}_{A}} , \frac{ϕ - {ϕ}_{i}}{{h}_{ϕ}} )$$

denotes a used kernel function. The common Gaussian kernel formula is:

$$K ( \frac{A - {A}_{i}}{{h}_{A}} , \frac{ϕ - {ϕ}_{i}}{{h}_{ϕ}} ) = exp ( - \frac{{( A - {A}_{i} )}^{2}}{{h}_{A}} - \frac{{( ϕ - {ϕ}_{i} )}^{2}}{{h}_{ϕ}} )$$

where h_{A}, h_{φ} are estimated bandwidths, typically obtained using the Silverman rule

$$h = {( \frac{4 {σ}^{5}}{3 N} )}^{\frac{1}{5}} ,$$

or the Scott rule h=N^{-1/6}σ.

Here, N is the total volume of data, e.g., the number of all elements in the matrix, and σ is the variance.

Here, Aᵢ is the i-th element in the magnitude matrix Aₘ or Aₙ, and φᵢ is the i-th element in the phase matrix φₘ or φₙ.

After obtaining the joint probability distribution f(A, φ), the original amplitudes and phases may be substituted to obtain the probability matrices Pₘ and Pₙ, e.g. the JSD may be calculated as follows:

$$JSD ( P , Q ) = \frac{1}{2} \sum {P}_{m} log ( \frac{{P}_{m}}{0.5 ( {P}_{m} + {P}_{n} )} ) + \frac{1}{2} \sum {P}_{n} log ( \frac{{P}_{n}}{0.5 ( {P}_{m} + {P}_{n} )} )$$

Additionally, when converting the probability distribution, a low-complexity computation method may also be used, such as respectively normalizing the amplitude matric and phase matric:

Aₙₒᵣₘ=A/(ΣA),φₙₒᵣₘ=φ/(Σφ)

The sum of all elements in the resulting matrice is 1, and the resulting matrices also may be represented as probability matrices. Afterwards, the JSD is calculated for the two amplitude probability matrices and the two phase probability matrices separately, and the final JSD is:

JSD=(JSD_magnitude+JSD_phase)/2

The output result of resource coordination may include resource for each user. For example, to meet the above objective, the result is best when User A and User C use different resources, while User B and User A use the same resource. Therefore, the output result of resource coordination is the resource allocated to each user. Additionally, users may be grouped into different sets based on whether the used resources are the same: Users {AB} form one multiplexing set, and User {C} forms another multiplexing set.

It should be understood that the resource coordination essentially selects resource and multiplexing scenario actually used by the user for the next time. The graph contains historical and currently received performance interference data when multiplexing. Then, the performance interference data may assist in the next resource coordination.

Optionally, the result of each resource coordination is that each user belongs to only one multiplexing set. For example, as shown in FIG. 5, User A has two multiplexing cases—one with User C and another with multiplexing user BC, which are obtained from historical cases. That is, one case involved User A and User C being multiplexed, while another case involved User A and multiplexing users BC being multiplexed. However, in a single transmission, User A may only be in one multiplexing user set.

When the resource coordination method based on the mutual interference effect graph is not used, a traditional resource coordination method is adopted.

After performing interference mitigation and sensing by the IGDM, the obtained signal quality is improved and overall performance is improved, that is, the model may mitigate channel interference and exhibits increased tolerance to interference. Since more user multiplexing introduces more interference, more users may be multiplexed under the condition of same performance results after IGDM processing. Resource coordination schemes based on interference mitigation effectiveness are designed based on the better signal quality and sensed interference obtained after the IGDM. Optionally, the signal quality after multiplexing may be obtained according to the signal quality (SINR) and remaining interference degradation. That is, accurate overall performance is obtained by performing resource coordination based on more accurate signal quality and interference. The interference effectiveness is used to obtain an interference value remained after multiplexing, e.g., an SINR degradation value caused by interference (interference offset).

Another resource coordination method is resource coordination based on interference mitigation effectiveness, which may further improve resource utilization and performance.

The interference mitigation effectiveness (effectiveness) is defined as:

The data corresponding to decoded result ‘ack’ is represented as ideal data ‘a’ corresponding to original transmission data (e.g., for quadrature phase-shift keying (QPSK), data may be mapped to corresponding constellation point, such as 1+i). The data sizes of input and output data signals of the IGDM are b and c, respectively, and b and c are processed as data with the same dimension based on ideal data dimension. Error vector magnitude (EVM) evaluates the EVM magnitude between a and b, and between a and c, denoted as EVM_{ab} and EVM_{ac}, respectively. The interference mitigation effectiveness is defined as: effectiveness=EVM_{ac}/EVM_{ab}.

The objective of resource coordination is:
P: max performance
   s.t. 1) multiplexed SINR=SINR−interference offset,
2) interference offset=sensed interference/effectiveness−sensed interference
   3) other limitations

The above constraint 3) may be arbitrary one or more existing constraint in networks, such as resource utilization, achieving specified QoS levels, or computational method constraint that should be satisfied user's correlation and/or JSD and/or other evaluation metrics of network, and/or a certain indicator. Optionally, the constraint 3) may be the correlation between users being less than a threshold, but not limited thereto.

Here, the interference offset is the finally evaluated interference magnitude, e.g., the magnitude of the remaining interference not mitigated calculated based on the interference mitigation effectiveness and sensed interference.

It should be noted that effectiveness may also be denoted by the letter E, then the above constraint 2) may be: interference offset=sensed interference (1−E)/E.

Based on the sensed interference magnitude and the estimated interference mitigation effectiveness, a relatively accurate interference magnitude may be obtained. When performing resource coordination, the accurate degradation SINR caused by interference (e.g., SINR after multiplexing) may be obtained.

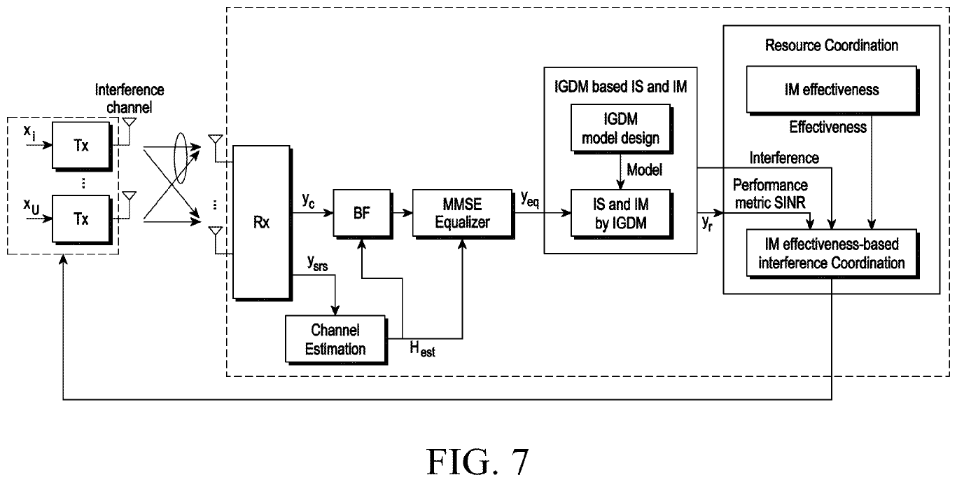

FIG. 7 illustrates an interference management system for resource coordination based on interference mitigation effectiveness according to an embodiment of the disclosure.

This system may include two main interference management processes: 1) an integrated IS and IM module based on IGDM; and 2) resource coordination based on IM effectiveness (which may also be described as a paired UE selection algorithm), which is an evaluation method based on IM effectiveness. Optionally, 2) is performed based on IS and IM results from 1). Therefore, both IS and IM are simultaneously performed by the IGDM.

The IGDM-based IS and IM in FIG. 7 may be understood as the IGDM model design section (including: weight design, derivation of Equation 8 (e.g., IGDM model design in FIG. 7) and the interference-noise sensing and mitigation section (IS and IM by IGDM in FIG. 7, where IS denotes interference sensing and IM denotes interference mitigation)) described below.

### III: Allocate Resources to Users

After the resource coordination, the resources allocated to the users are distributed to the users, and signals are transmitted by the users on the allocated resources to the receive side.

### IV: Perform BF Design Based on Mutual Interference Effect Graph

The BF design is performed based on the mutual interference effect graph. That is, after receiving a signal transmitted by a user, according to multiplexing user set information after resource coordination and interference magnitude information obtained in the mutual interference effect graph, the optimal number of antennas to be adopted is determined or the combined weights are adjusted based on the interference magnitude when designing the BF weights, ensuring that the adjusted performance meets the requirements. If no valid interference is obtained in the graph, the interference is considered as 0.

Optionally, the method for performing BF design based on the mutual interference effect graph comprises:

Method 1: Performing SVD decomposition on the estimated channel matrix and taking a characteristic matrix composed of the top M eigenvectors with the largest eigenvalues as the BF weights. Based on interference magnitude of the multiplexing users in the graph, the characteristic matrix composed of the top M-K eigenvectors is taken as the final BF weights. The value of K is related to the interference magnitude, where the greater the interference is, the larger the value of K is. To avoid performance loss in the received signal, limit M−K≥L. Here, L is the number of eigenvectors corresponding to the channel matrix, taken as an integer greater than 1.

Method 2: Reconstructing an interference matrix based on the interference magnitude obtained in the graph, as shown in FIG. 16B.

FIG. 16B is a schematic diagram of a BF method based on interference matrix reconstruction according to an embodiment of the disclosure.

After obtaining the channel estimation matrix, the interference matrix is subtracted from the channel estimation matrix to obtain a new channel matrix. The BF design is performed using traditional method such as SVD, precoding matrices, or maximum ratio combining based on the new channel matrix after de-interference.

Method 3: Calculating channel combined weights based on the estimated channel, and combining data of all antennas into fewer antenna weights. The combined weights may be adjusted based on the magnitude of interference between multiplexing users and the directivity of the combined weights, thereby concentrating a user's signal toward the direction with better signal quality.

The process of adjusting the combined weights may comprise: obtaining the combined weights of multiple users, then adjusting the combined weights (e.g., direction) by integrating interference magnitudes of any two multiplexing users, and pointing them toward the position with lower interference. The user signal quality after adjusting the combined weights is calculated. If the signal quality becomes good, the adjusted combined weights are used.

After the resource coordination, if the multiplexing user sets include both {ABC} and {D}, and UE A is only interfered by UE B and UE C, then the weights may be adjusted based on the magnitude of interference of UE B on UE A, the magnitude of interference of UE C on UE A obtained in the graph and the performance. If UE B causes significant interference on UE A, then UE A's weight direction may be adjusted to deviate further from UE B. Here, the BF combined weight is a spatial directional weight.

Optionally, the signal quality may be estimated based on the currently adjusted combined weights (e.g., re-evaluate the combined signal quality using the adjusted weights). If the signal quality is poor, the weights are not adjusted.

It should be noted that when the BF weights designed based on the graph is not used, a traditional BF weight design method is used.

### V: Equalization and SIC Cancellation

The signal after BF is equalized using an equalization module such as MMSE/ZF. It is possible to perform SIC cancellation on the equalized signal. The SIC module, serving as an interference mitigation module, is optional, and whether to use it or not depends on hardware complexity, performance cost, and the like.

The IGDM may perform interference mitigation for each of users in parallel. Alternatively, a serial approach may be used to further enhance interference mitigation performance. That is, multiplexing users are sorted according to received signal quality. For the first user, interference mitigation is performed according to the IGDM method, and for the second user, IGDM mitigation is performed on a signal in which the signal after interference mitigation of the first user is subtracted from the received signal. For each of the subsequent users, IGDM interference mitigation is performed after subtracting all previously processed user signals from the received signal. This serial approach may further optimize input signal quality and improve the performance of the signal after interference mitigation.

### VI: IGDM-Based Interference Mitigation and Sensing

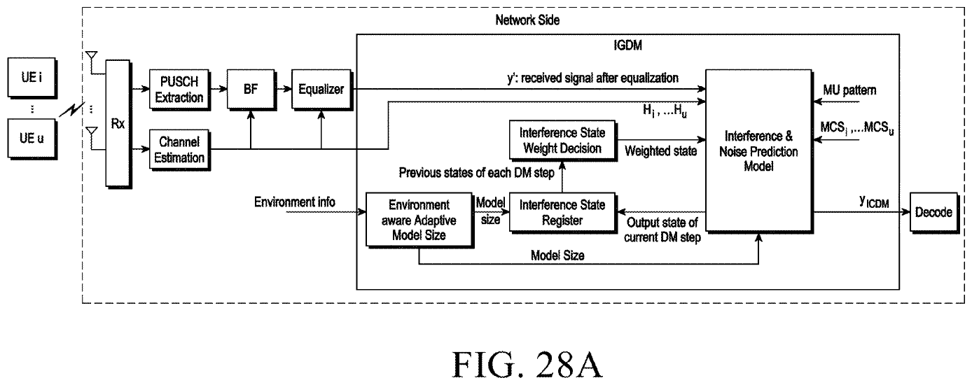

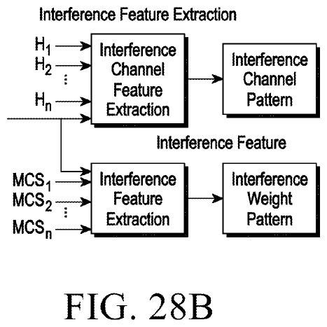

The IGDM-based interference mitigation and sensing method is required to design the IGDM model. In the model, a de-interference and de-noising model (e.g., an interference pattern guided diffusion model) is designed according to interference-related information based on a diffusion model (DM), and the interference is modeled. The position and structure of the IGDM within the communication system are as shown in FIG. 28A.

FIG. 28A is a structural schematic diagram of an IGDM-based communication system according to an embodiment of the disclosure.

Specifically, the overall structure of the interference pattern guided diffusion model IGDM is as shown in FIG. 16C.

FIG. 16C is a schematic diagram of an overall structure of an IGDM according to an embodiment of the disclosure.

The model comprises an environment-aware model size decision module and an interference sensing mitigation module. The interference sensing mitigation module may include a guidance condition obtaining module, a multiple-state processing module, DM processing steps based on anti-interference requirements, and a DM-based interference sensing mitigation module. The inputs to the IGDM include the estimated channels of the multiplexing users, the MCS of the multiplexing users, pairing information of the multiplexing users in each frequency band, and the received signal after MMSE.

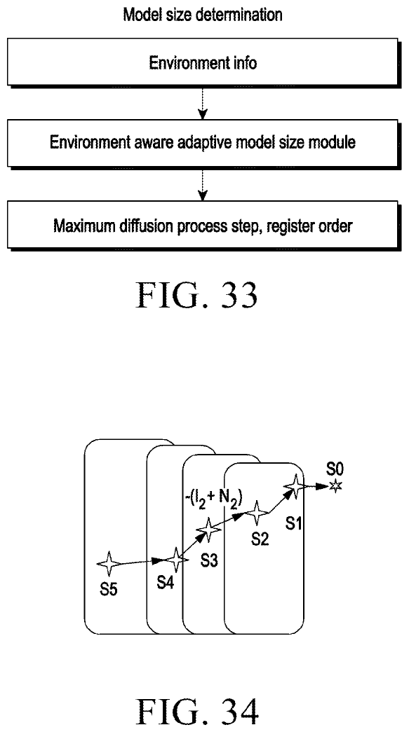

In some embodiments, the environment-aware model size decision module is used to decide the maximum model size for the interference sensing and mitigation module, as shown in FIG. 33.

FIG. 33 is a schematic diagram of input and output of an adaptive model size decision module according to an embodiment of the disclosure.

Due to the complexity of communication environments, different environments present different channel and interference conditions, and the users' anti-interference requirements are also different. Using a uniform model size for interference processing may result in excessive or insufficient processing steps, whereby leading to degraded performance. To achieve more efficient and less complex interference mitigation, an environment-based adaptive model size decision module is proposed. This module obtains the maximum number of diffusion processing steps and the order of registers for storing historical diffusion states based on environmental information, as shown in FIG. 33.

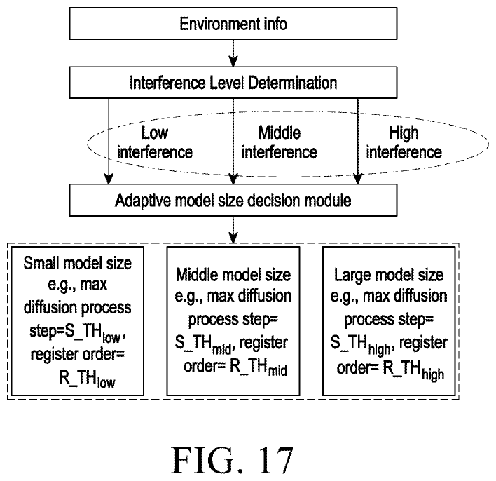

Here, the model size may include the maximum number of DM steps T and the number of states q of the multiple-state processing module, as shown in FIG. 17.

FIG. 17 is a schematic diagram of an environment-aware model size decision module according to an embodiment of the disclosure.

Determining different model sizes based on different environments may reduce processing complexity in certain environments.

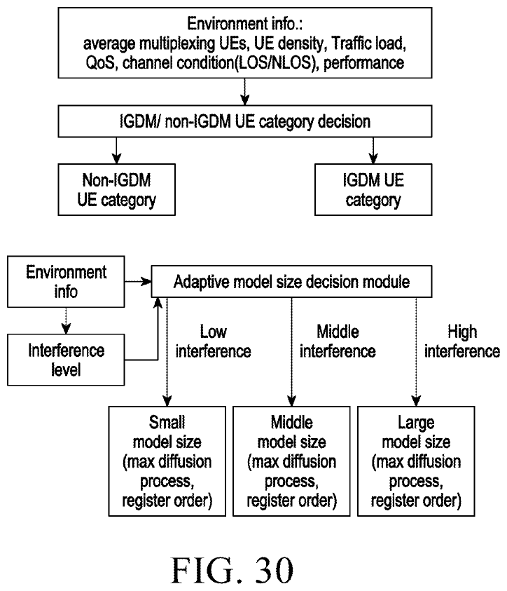

The environmental-aware model size decision module may firstly statistically determine whether the UE's received signal quality meets quality of service (QoS) requirements based on environmental parameters, and then categorize users into two classes: IGDM-type and non-IGDM-type users, as shown in FIG. 30.

FIG. 30 is a schematic diagram of an environment-aware model size decision module according to an embodiment of the disclosure.

The environmental parameters include user signal reception delay, SINR, Tput, and etc. as well as quality metrics related to QoS requirements. For non-IGDM-type users, no IGDM is required to perform interference mitigation. For IGDM-type users, the IGDM is required to perform interference mitigation. For IGDM-type users, their corresponding environmental information, such as user denfactors which are related to the user's environment and affect received signal quality (including user density, traffic volume, average number of multiplexing users, channel conditions, etc.), is input; the magnitude of interference experienced by the user is determined based on the environmental information; and users are classified into three levels: high interference, medium interference, or low interference. Taking the average number of multiplexing users and interference user's performance as an example, the classifying interference environment levels is as shown in Table 1. For users with interference user's performance below a threshold (Th_{low}) and average number of multiplexing users below a threshold (Nth_{low}), the environment level thereof is classified as low interference. For users with interference user's performance between low threshold (Th_{low}) and high threshold (Th_{high}) and the average number of multiplexing users below the threshold (Nth_{low}), the environment level thereof is classified as medium interference. The remaining level classifications are detailed in Table 1 below.

TABLE 1

| | | Interference UEs' performance | | |
|---|---|---|---|---|
| | | <Th_{low} | Th_{low}~Th_{high} | >=Th_{high} |
| Number of | <Nth_{low} | Low | Middle | Middle |
| multiplexing | Nth_{low}~Nth_{high} | Middle | Middle | High |
| UEs | >=Nth_{high} | Middle | High | High |

When using three or more environmental parameters for level classification, the table may be expanded into a multidimensional parameter combination, with levels being classified based on ranges of each parameter. The adaptive model size decisions for different levels are as shown in FIG. 17.

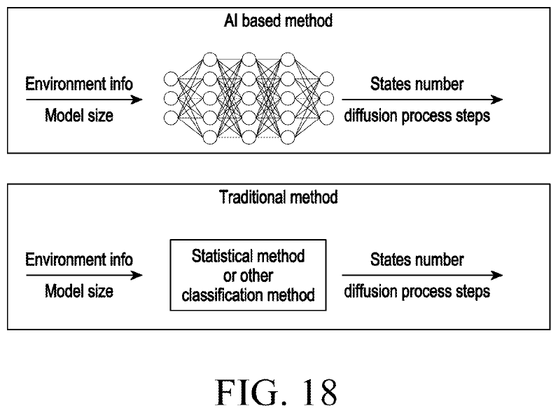

The adaptive model size decision module may employ an AI model (such as CNN) to learn to determine the maximum model size, or utilize traditional statistical or other classification methods to determine the maximum model size. The module's inputs include environmental information corresponding to environmental factor (channel, etc.) and user' performance (SINR/TPUT, etc.) and the historical maximum model size, as show in FIG. 18.

FIG. 18 is a schematic diagram of a model size decision structure according to an embodiment of the disclosure.

For example, channel/interference environment user's performance, and historical model sizes are used as inputs into CNN network, it is determined by learning that under the low interference environment level, the maximum number of DM operations of a user is 100, and the number of states is 3, achieving 2 dB SINR improvement; and under the high interference environment level, the maximum number of DM operations of a user is 800, and the number of states is 5. As interference levels vary from high to medium to low, the model size gradually become small. Users in the same environment employ the same model size, the cases of multiplexing users are teal-time evaluated, and after a user's environment is changed, the above process is repeated to determine the maximum model size. If the user's environment changes to an interference-free scenario, the IGDM is no longer required.

After the maximum model size is determined, the IGDM corresponding to the maximum model size is used to perform interference sensing and mitigation for the user. The IGDM processing may include:

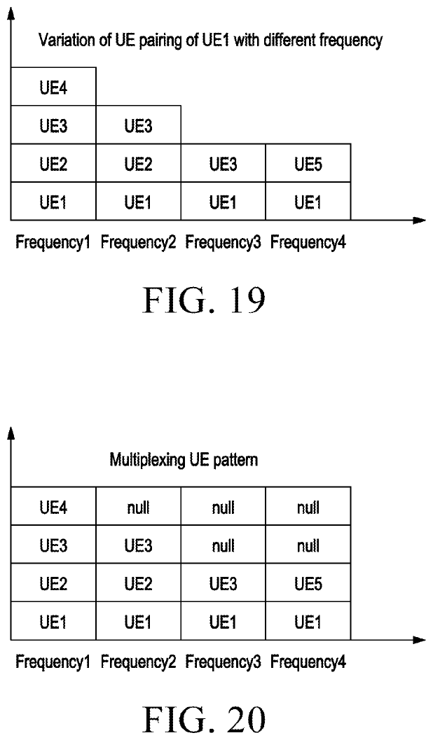

Since bandwidths required to transmit signals by users in respectively slots are different, different multiplexing users are on different frequency bands, as shown in FIG. 19.

FIG. 19 is a schematic diagram of a case of multiplexing users on different frequency bands according to an embodiment of the disclosure.

The correlation between pairing users causes coupling between signal and interference, and pairing on the different frequency bands cause changes in coupling characteristics. To effectively mitigate interference under the changes in the user pairing information and interference coupling characteristics, utilizing interference characteristics as a guide for interference mitigation is proposed. The interference characteristics include interference intensity and angle. The pattern adapts to different user pairing scenarios, while interference and signal are decoupled by using the intensity and phase of interference characteristics. Here, the intensity of interference characteristics may be obtained by a method such as multiplying SINR/MCS/power by the estimated channel. The phase is a known phase of the estimated channel.

Firstly, the interference-related information is obtained based on the multiplexing pattern of the multiplexing users and/or the channel information of the interference user and/or the interference intensity (which may be obtained based on SINR/MCS/power, etc.). The interference-related information is represented in the form of a pattern, with the processing being as shown in FIG. 28B (using MCS as an example for obtained intensity information).

FIG. 28B is a schematic diagram of interference characteristic extraction in variable user pairing according to an embodiment of the disclosure.

The interference-related pattern is used to quantitatively define the features of the interference user, thereby distinguishing between the interference user and target user to a larger extent and improving the effect of interference mitigation.

When considering User 1 as the target user and performing interference mitigation for User 1, it is firstly necessary to obtain the case of the multiplexing users with User 1 on different frequency bands, as shown in FIG. 19. To ensure consistent data dimensions during de-noising, empty user information is added to frequency bands with missing dimensions, a multiplexing user pattern is formed as shown in FIG. 20.

FIG. 20 is a schematic diagram of a multiplexing user pattern according to an embodiment of the disclosure.

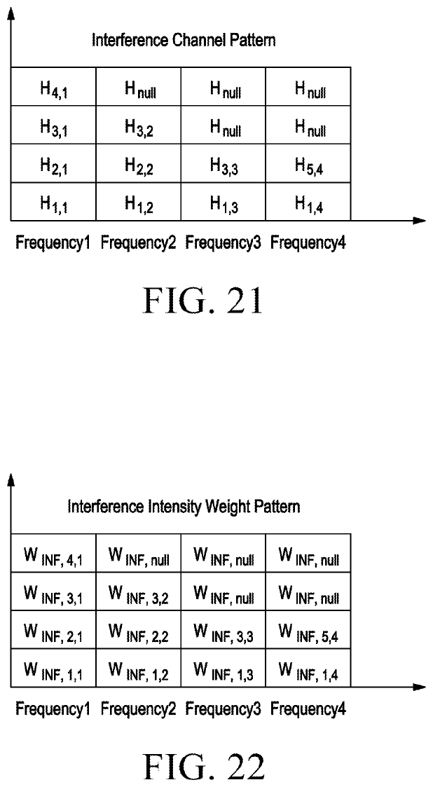

Due to the correlation among the multiplexing users, to better distinguish respective received signal features of the target user and the interference user among the multiplexing users, the interference-related information is obtained using the estimated channel and received signal intensity indicator of the multiplexing users. For the multiplexing user pattern, the interference-related information is represented using the pattern. Interference-related information pattern may include channel pattern of the interference user transmitting signal to the receive terminal, and pattern of weight of intensity of the received signal from the interference user. The interference channel pattern involves correspondingly filling the estimated channels of the target user and the multiplexing users into corresponding positions of the multiplexing user pattern, with empty users represented by zero channels, as shown in FIG. 21.

FIG. 21 is a schematic diagram of an interference channel pattern according to an embodiment of the disclosure.

To obtain the interference intensity weight pattern, the interference intensity information is firstly obtained, where interference intensity represents intensity proportion (weight) of each of the target user and the multiplexing user in the mixed received signal. The received signal intensity (power multiplied by the estimated channel P*H), SINR of the received signal, SINR of the reference signal, or the modulation and coding scheme (MCS) may be used to represent the received signal intensity Intensityᵢ for each multiplexing user. The sum of received signal intensities for all the multiplexing users is calculated as Intensityₛᵤₘ. The intensity ratio for each multiplexing user is W_{Int,ij}=Intensity_{i,j}/Intensityₛᵤₘ. Here, i denotes the user, and j denotes the j-th frequency band of the target user. Taking the MCS as an example, assuming that there is one frequency band, then

$${W}_{I N F . i} = M C {S}_{\underline{i}} / {\sum }_{k = 1}^{n} MC {S}_{k} .$$

The intensity ratios of the target user and the interference user correspond (map) to the multiplexing user pattern, and empty users are represented by zero intensity ratios, thereby obtaining the interference intensity weight pattern as shown in FIG. 22.

FIG. 22 is a schematic diagram of an interference intensity weight pattern according to an embodiment of the disclosure.

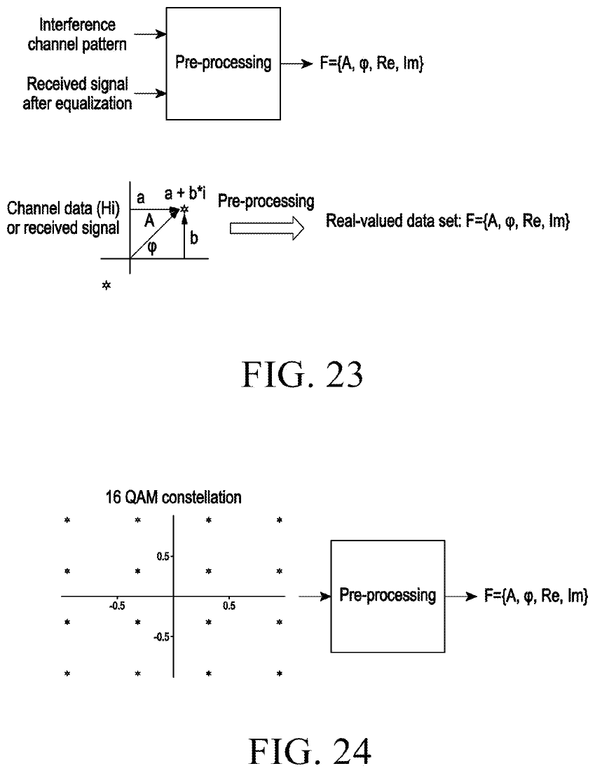

Since both the received communication signal and the channel matrix are complex signals, each complex value is represented as a point in a two-dimensional coordinate system (with real and imaginary parts as the horizontal and vertical axes, respectively). In order to perform DM processing, preprocessing is required to convert the channels in the interference channel pattern and the equalized received signal into real numbers F=(A, φ, Re, Im), where A is the amplitude, φ is the phase, Re is the real part, and Im is the imaginary part, as shown in FIG. 23. Preprocessing is the process of obtaining the amplitude, phase, real part, and imaginary part and combining them into a set F.

FIG. 23 is a schematic diagram of channel data and received data preprocessing and processed symbol representation according to an embodiment of the disclosure.

Additionally, a user transmits a signal with a given MCS on the corresponding frequency band. Each MCS corresponds to a respective modulation method, as shown in FIG. 38, such as QPSK, 4QAM, 16QAM, 32QAM, 64QAM, 256QAM, and the like.

FIG. 38 is a schematic diagram of an MCS and constellation diagram according to an embodiment of the disclosure.

Each modulation method corresponds to a different constellation diagram, that is, the modulated signal always corresponds to a certain point in the constellation diagram. Therefore, the MCS as a characteristic of the target user may serve as input, thus providing additional information for interference mitigation, as shown in FIG. 16C. However, since a point in the constellation diagram represents a complex signal, it also requires preprocessing to be converted into a real number F=(A, φ, Re, Im), as shown in FIG. 24.

FIG. 24 is a schematic diagram of constellation point value preprocessing according to an embodiment of the disclosure.

The interference channel pattern, the interference intensity weight pattern, the equalized received signal, and the target user's MCS are used as DM inputs, wherein the interference channel pattern and the interference intensity weight pattern serve as conditional inputs to the DM model, guiding the DM to predict interference and mitigate interference.

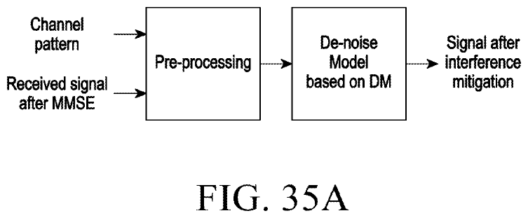

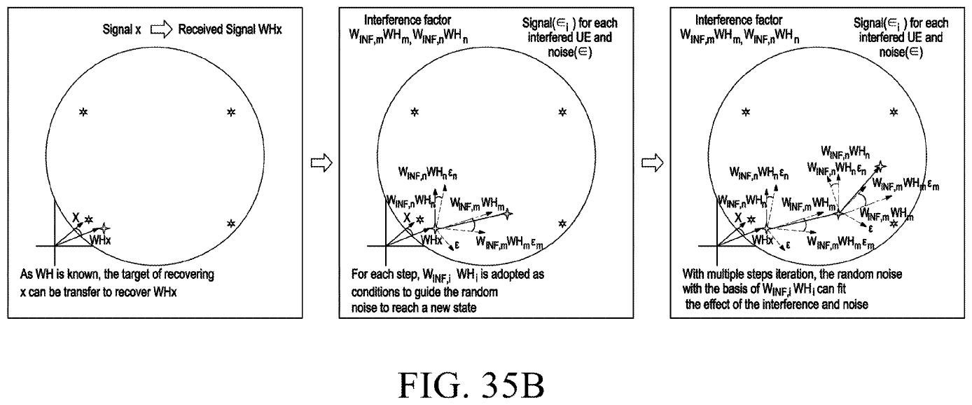

Firstly, for the received signal, y′=W*(Hx+Hₙxₙ+n), where x and xₙ are unknown transmitted signals, affecting the effect of interference mitigation. To improve the accuracy, the interference signal pattern and the interference intensity weight pattern are used as guidance. The input-output schematic of the model is as shown in FIG. 35A.

FIG. 35A is a schematic diagram of input and output of a DM-based de-noising model according to an embodiment of the disclosure.

The interference channel pattern H is the channel experienced by multiplexing users, which may cause phase deviations of signals in the constellation diagram. The interference intensity weight pattern refers to intensity ratio W_{Int,ij} of each of multiplexing user signals that are superimposed together, guiding the influence on interference intensity. At each processing step in the DM, the unknown transmitted signals ϵᵢ and the noise ϵ of each interference user are treated as independent signals, which are then superimposed to produce the effect. The process of predicting ϵᵢ and ϵ at each step utilizes interference intensity and channel patterns as guidance, as shown in FIG. 35B.

FIG. 35B is a schematic diagram of an interference channel pattern and interference weight pattern guided noise and interference prediction DM process according to an embodiment of the disclosure.

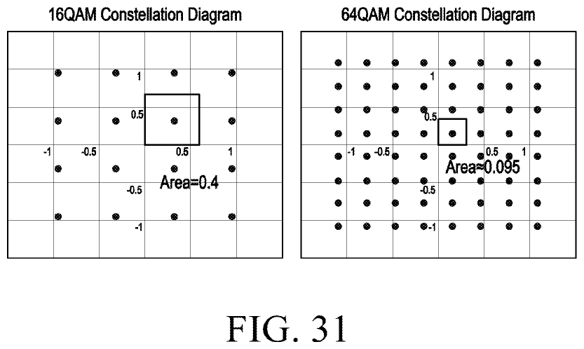

Since the constellation diagram differs for the target user' MCS, constellation points with lower modulation order exhibit a larger spacing, as shown in FIG. 31.

FIG. 31 is a schematic diagram of decision areas for different modulation formats according to an embodiment of the disclosure.

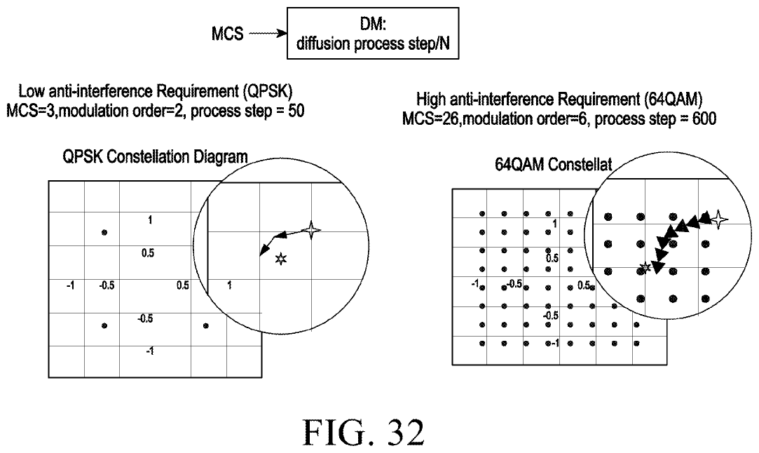

FIG. 32 is a schematic diagram of MCS-based interference mitigation under different steps according to an embodiment of the disclosure.

This results in a larger soft decision area during decoding, as shown in Table 2. Therefore, low MCS levels demonstrate higher interference tolerance. The MCS represents the anti-interference requirement. For users with low anti-interference requirement, the number of de-interference steps may be reduced without more accurate interference mitigation, improving the efficiency of DM processing, as shown in FIG. 32. Although multi-step DM process requires significant processing time, the multi-step DM process may be condensed into a 2-4 step model by a distillation method, as illustrated in FIG. 37.

FIG. 37 is a schematic diagram of a distillation model according to an embodiment of the disclosure.

This reduces process latency, thereby meeting communication system latency requirement. Furthermore, an initial DM model with fewer steps may improve distillation efficiency and the number of steps after distillation is reduced, thereby reducing process latency.

TABLE 2
Modulation Levels and Soft-Decision Area
Sizes for Different Modulation Formats

| Modulation | Modulation order | Soft-decision area |
|---|---|---|
| QPSK | 2 | 2 |
| 16QAM | 4 | 0.4 |
| 64QAM | 6 | 0.095 |
| 256QAM | 8 | 0.024 |
| 1024QAM | 10 | 0.006 |
| . . . | . . . | . . . |

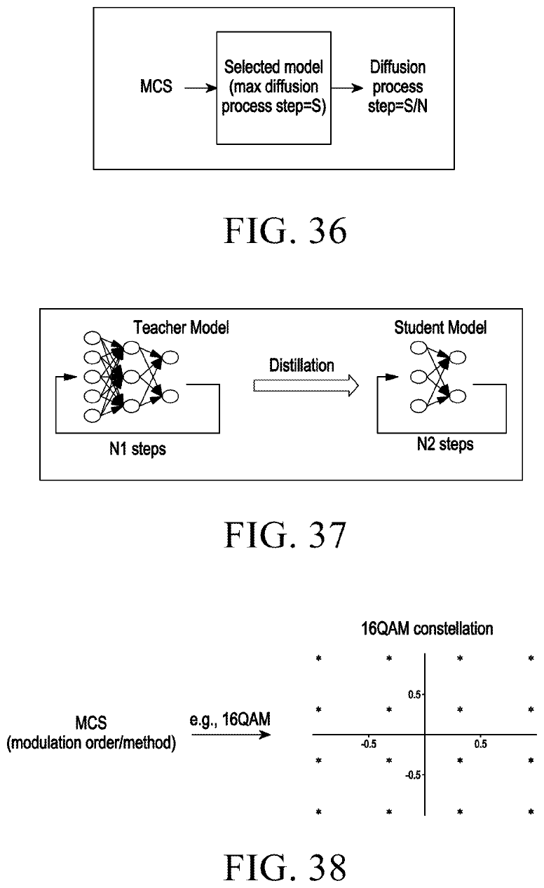

Based on the MCS levels, the steps of the DM model with maximum number of steps T are further reduced. The final number of DM steps is T1=T/normalized (Modulation order), as shown in FIG. 36.

FIG. 36 is a schematic diagram of reducing diffusion model steps based on MCS according to an embodiment of the disclosure.

High modulation levels require more DM steps to obtain more accurate interference prediction and mitigation results.

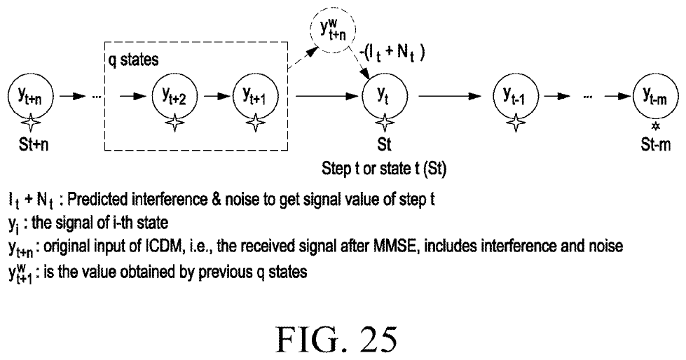

Each step of the DM predicts the interference magnitude I and Gaussian white noise N. After each step, the predicted interference value is subtracted from the equalized received signal obtained in the previous step to obtain the signal value for that step. This process is based on a Markov chain, with each step corresponding to a state S, as shown in FIG. 25.

FIG. 25 is a schematic diagram of diffusion model (DM) processing based on multiple-state weighting according to an embodiment of the disclosure.

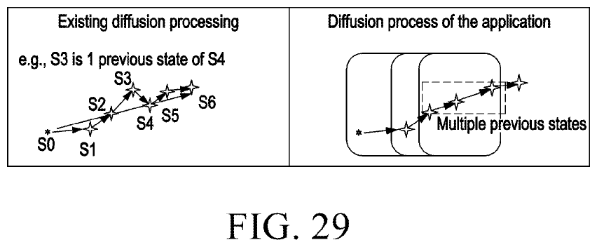

Obtaining the value of the next state based on the previous state will lead to significant fluctuations in states, thus reducing the model's robustness. Therefore, the disclosure obtains weighted state values based on historical q state information. The next operation of the DM operation is performed on these weighted state values (as shown in FIG. 25), reducing fluctuations between state and making change in each state smoother, and improving the efficiency and robustness of DM process, as shown in FIG. 29.

FIG. 29 is a schematic diagram of the smoothing effect of multiple-state DM processing according to an embodiment of the disclosure.

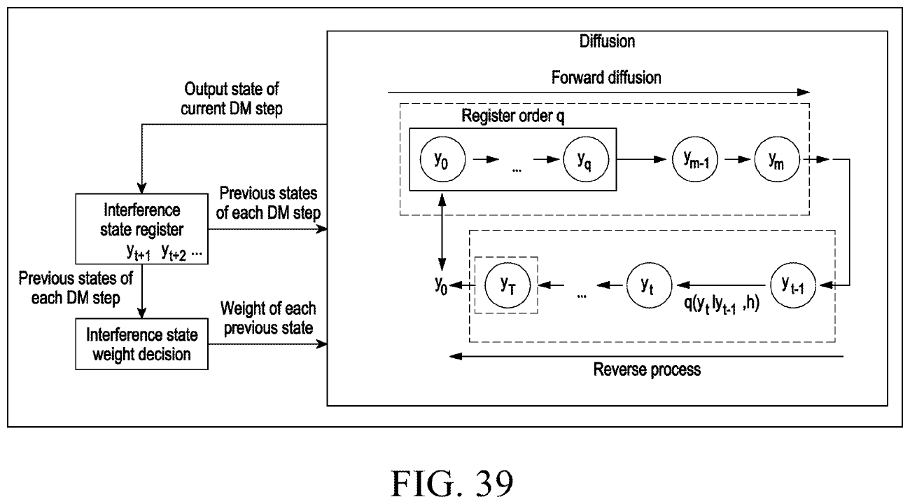

To store the previous q states, a q-order interference state register is utilized to record state values. Based on the recorded multiple states, the weight of each state is calculated, and the weighted values are calculated to obtain smoothed state values, to reduce fluctuations and improve the model's robustness. The processing flowchart is as shown in FIG. 39.

FIG. 39 is a schematic diagram of a process of DM processing based on multiple-state registers according to an embodiment of the disclosure.

FIG. 34 is a schematic diagram of q=2 multiple-state processing according to an embodiment of the disclosure.

States processed in each processing contain q states, e.g., performing de-noising on the next operation using a sliding window form, as shown in FIG. 34.

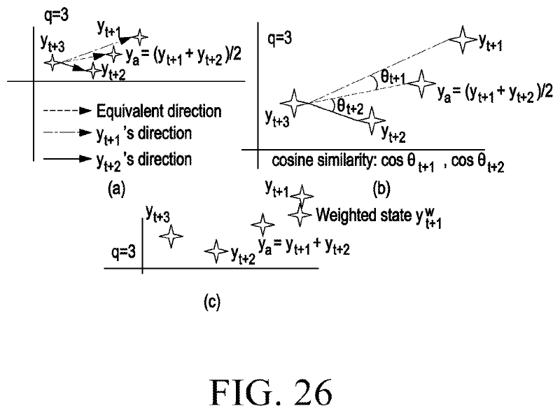

FIG. 26 is a schematic diagram of a weighted state value calculation according to an embodiment of the disclosure.

Here, the obtaining of the weighted state values

$${y}_{t + 1}^{w}$$

is related to the previous q states, and the calculation method is as follows:
obtaining values yₜ₊₁, yₜ₊₂ . . . y_{t+q} corresponding to the q states;
averaging the last q−1 states obtained from the q states to obtain yₐ,
defining the direction from y_{t+q} to yₐ as an equivalent direction, e.g., the data change direction processed by the DM, as shown in part (a) of FIG. 26;
calculating a cosine similarity cos θᵢ (i=1, 2 . . . q) between the finally obtained q state directions and the equivalent direction, as shown in part (b) of FIG. 26, and using cos θᵢ as weights for the q states.

The weighted state values are calculated as

$${y}_{t + 1}^{w} = {\sum }_{j = 1 … q} {w}_{i} {y}_{i} ,$$

as shown in part (c) of FIG. 26.

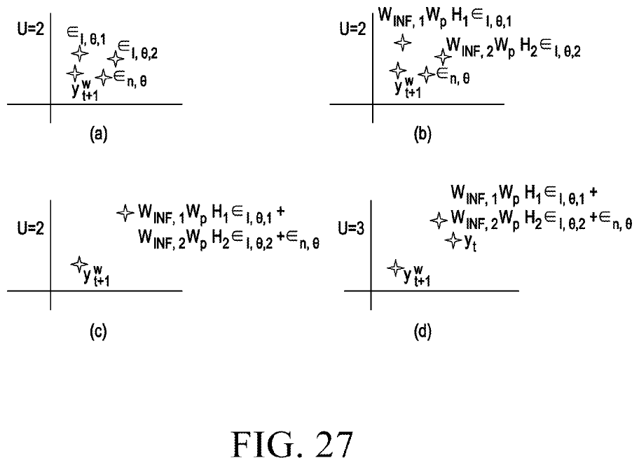

FIG. 27 is a schematic diagram of an interference noise prediction and state value calculation for step t according to an embodiment of the disclosure.

For the transmitted signal xᵢ to the target user i, after undergoing signal Hᵢ, the signal becomes Hᵢ*xᵢ. Simultaneously, due to interference from multiplexing users, the signal of user i is mixed together with interference signals of transmitted signals from other multiplexing users (e.g., H₁x₁, H₂x₂) and received by the receive terminal, while also degraded by the Gaussian white noise n. Therefore, for each DM processing step, interference and noise prediction are performed based on the weighted state values

$${y}_{t + 1}^{w}$$

from the previous step and the interference information-related graph. Here, the user's transmitted signal x and noise are unknown and generated by DM prediction, as shown in part (a) of FIG. 27. The channel experienced by the signal and the received intensity may be determined by the estimated channel H₁, H₂, and the intensity weight W_{INF,1}, W_{INF,2}, as shown in part (b) of FIG. 27. Thus, this quantitatively defines the signal. The uncertainty in interference information is reduced to make prediction more accurate. Here, W denotes processing applied to the user's transmitted signal at the receive terminal (e.g., BF, equalization, etc.). After predicting the interference and noise, the sum of all interference and noise constitutes the total interference and noise, as shown in part (c) of FIG. 27. The interference and noise are subtracted from

$${y}_{t + 1}^{w}$$

to obtain a signal value at step t

$${y}_{t} = {y}_{t + {1}^{-}}^{w} ( {W}_{INF , 1} {WH}_{1} {ϵ}_{I , θ , 1} + … + {W}_{INF , U - 1} {WH}_{U - 1} {ϵ}_{I , θ , U - 1} + {ϵ}_{n , θ} ) ,$$

where U is the number of multiplexing users, as shown in part (d) of FIG. 27.

Here, the signal input to the interference diffusion model to be de-interference processed is related to the process after the signal is received on the network side. The input received signal is designed to take the form of diffusion weights suitable for the diffusion model. Through the designed weights, the interference is modeled as a weighted term in the diffusion model. Specifically:

### 1) Design Interference Diffusion Weights.

The model for the received signal of user i is:

$$Equation 1$$

$${y}_{c , i} = {h}_{c , i} * {x}_{c , i} + {\sum }_{{k = 1 : U}_{k \neq i}} {h}_{c , k} * {x}_{c , k} + {n}_{c , i} \qquad ( 1 )$$

h_{c,i} is the complex-valued channel of user i. h_{c,k} is channel (complex-value) of the interference user. h_{c,i}, h_{c,k}∈ [symbol] [symbol] (0,1) is an independent and identically distributed Rayleigh fading channel. The real-valued channel matrix of user i is

$${h}_{r , i} = [ \begin{matrix}\vert {h}_{c , i} \vert \\ \vert {h}_{c , i} \vert\end{matrix} ] .$$

The number of users multiplexed with user i is U, x_{c,i} is the complex signal transmitted by user i, with dimension of Q*1, x_{c,k} is complex signal transmitted by interference user k, with dimension of Q*1, and transmit power of x_{c,i} meets [symbol] [|x_{c,i}|²]≤1 (or normalized), n_{c,i} is complex Gaussian white noise, and n_{c,i}, n_{c,k}∈ [symbol] [symbol] (0, 2σ²). x_{r,i} is real-valued received signal with dimension of 2Q*1, and n_{r,i} is real-valued Gaussian noise.

Considering that diffusion weight design is performed for signals y_{c,i,p} after signals y_{c,i} Of y_{c,i} pass through any module in BF/equalization/SIC. That is, the IGDM module may replace all or a part of current signal processing on the receive side (BF, equalization, SIC), or be placed after all existing processing modules. Let W_{p,i} denote processing operation applied to y_{c,i}, with the same meaning as W described before. Then y_{c,i,p} is:

y_{c,i,p}=W_{p,i}*h_{c,i}*x_{c,i}+W_{p,i}Σ_{k=1:U}h_{c,k}*x_{c,k}+W_{p,i}*n_{c,i} (2)

Equation 2

If no processing is performed on y_{c,i} (the IGDM replaces all current processing modules), then y_{c,i,p} equals Equation 1. If the processing operation is BF (the IGDM replaces the remaining processing modules after BF), then W_{p,i}=W_{bf,i}, W_{bf,i} are the BF weights. If the processing operation includes equalization (the IGDM is located after all current processing modules), then W_{p,i}=W_{eq,i}*W_{bf,i}. After the equalization followed by SIC processing, W_{p,i} is identical to the model after equalization only.

y_{r,i,p} is the real-valued received signal:

$$Equation 3$$

$${y}_{r , i , p} = {W}_{p , i} * {h}_{r , i} * {x}_{r , i} + {W}_{p , i} * {\sum }_{{k = 1 : U}_{k \neq i}} {h}_{r , k} * {x}_{r , k} + {W}_{p , i} * {n}_{r , i} \qquad ( 3 )$$

If y_{r,i,p} is normalized, then:

$$Equation 4$$

$${y}_{r , i , p} = \frac{{W}_{p , i} * {h}_{r , i} * {x}_{r , i}}{\sqrt{U + {σ}^{2}}} + \frac{1}{\sqrt{U + {σ}^{2}}} {W}_{p , i} ( {\sum }_{{k = 1 : U}_{k \neq i}} {h}_{k} * {x}_{r , k} ) + \frac{1}{\sqrt{U + {σ}^{2}}} {W}_{p , i} * {n}_{r , i} = \frac{{w}_{p , i}}{\sqrt{U + {σ}^{2}}} ( {x}_{r , i} + {x}_{l , i} + {n}_{r , i} ) \qquad ( 4 )$$

Under the known h_{r,i}, x_{r,i}, the conditional distribution of the interference signal X_{I,i} is p(x_{I,i}|h_{r,i})~ [symbol] (0, |W_{p,i}|*(U−1)), the distribution of the noise term

$${n}_{r , i}^{′} is p ( {n}_{r , i}^{′} \vert {h}_{r , i} ) \sim 𝒩 ( 0 , {\vert {W}_{p , i} \vert}^{2} * {σ}^{2} ) , then$$

$$p ( {y}_{r , i , p} \vert {x}_{r , i} , {h}_{r , i} ) \sim 𝒩 ( {y}_{r , i , p} ; \frac{1}{\sqrt{U + {σ}^{2}}} {W}_{p , i} * {h}_{r , i} * {x}_{r , i} , \frac{1}{\sqrt{U + {σ}^{2}}} \vert {W}_{p , i} \vert * ( U - 1 ) , \frac{1}{U + {σ}^{2}} {\vert {W}_{p , i} \vert}^{2} * {σ}^{2} ) .$$

The designed interference diffusion weights are W_{s,i}, W_{I,i} and W_{n,i}, representing weights for useful data items, interference data items, and noise items, respectively.

ϵⱼ, ϵ~ [symbol] (0, I) are probability density distributions of interference and noise, I∈ [symbol] . Then:

$$Equation 5$$

$${y}_{r , i , p} = \frac{1}{\sqrt{U + {σ}^{2}}} {W}_{s , i} * {x}_{r , i} + \frac{U - 1}{\sqrt{U + {σ}^{2}}} \vert {W}_{p , i} \vert {ϵ}_{l} + \frac{σ}{\sqrt{U + {σ}^{2}}} \vert {W}_{p , i} \vert ϵ \qquad ( 5 )$$

A general de-noising diffusion model is:

xₜ=\sqrt{αₜ}xₜ₋₁+\sqrt{1−aₜ}ϵ (6)

Equation 6

According Equations 5 and 6, if

$${α}_{t} = \frac{1}{U + {σ}^{2}} , then 1 - {α}_{t} = \frac{U - 1 + {σ}^{2}}{U + {σ}^{2}} ,$$

and the following equation is designed:

$$Equation 7$$

$${y}_{r , i , p} = \frac{1}{\sqrt{U + {σ}^{2}}} {W}_{s , i} * {x}_{r , i} + \frac{\sqrt{U - 1 + {σ}^{2}}}{\sqrt{U + {σ}^{2}}} {W}_{I , i} {ϵ}_{I} + \frac{\sqrt{U - 1 + {σ}^{2}}}{\sqrt{U + {σ}^{2}}} {W}_{n , i} ϵ , \qquad ( 7 )$$

$$where$$

$${W}_{s , i} = {W}_{p , i} * {h}_{r , i} , {W}_{l , i} = \vert {W}_{p , i} \vert * \frac{U - 1}{\sqrt{U - 1 + {σ}^{2}}} , {W}_{n , i} = \vert {W}_{p , i} \vert * \frac{σ}{\sqrt{U - 1 + {σ}^{2}}} .$$

### 2) Design Interference Channel Diffusion Model (IGDM)

The interference channel weights of DM are re-designed. Based on the designed weights, the interference is modeled as additional weighted noise in DM, termed IGDM. This model is a diffusion model that mitigates both interference and noise.

According to Equation 7, y_{r,i,p} may be written as a diffusion form, that is:

y_{t,i}=\sqrt{αₜ}y_{t-1,i}+\sqrt{1−αₜ}(W_{I}ϵ_{I}+Wₙϵ) (8)

Equation 8

Equation 8 is an IGDM model. y_{0,i} is the initial signal without noise interference, while y_{0,i}=W_{s,i}*y_{r,i}, y_{0,i} become y_{t,i} after t steps of noise addition. y_{t,i} is subject to the conditional distribution.

$$q ( {y}_{t , i} \vert {y}_{0 , i} , {h}_{r , i} ) ∼ 𝒩 ( {y}_{t , i} ; \sqrt{{α}_{t}} {y}_{0 , i} , \sqrt{1 - {α}_{t}} {W}_{I} + ( 1 - {α}_{t} ) {W}_{n}^{2} )$$

That is, through the diffusion model, the conditional distributions of y_{t,i} and y_{r,i,p} are consistent, which may be evaluated by Kullback-Leibler (KL) divergence:

D_{KL}(q(y_{t,i}|y_{0,i},h_{r,i})∥p(y_{r,i,p}|y_{0,i},h_{r,i}))=0.

Through training by the forward diffusion process, the distribution of y_{r,i,p} is learned, then the reverse operation is utilized to mitigate noise and interference. That is, in the process of forward diffusion training, it is desired to make the loss function

$${𝔼}_{{y}_{0 , i} , ϵ , t} ( {‖ ( {W}_{I} {ϵ}_{I} + {W}_{n} ϵ ) - ( {W}_{I} {ϵ}_{I , θ} ( {y}_{t , i} , {h}_{r , i} , t ) + {W}_{n} {ϵ}_{θ} ( {y}_{t , i} , {h}_{r , i} , t ) ) ‖}_{2}^{2} )$$

less than a set threshold, where ϵ_{I,θ}(y_{t,i}, h_{r,i}, t) and ϵ_{θ}(y_{t,i}, h_{r,i}, t) are the output values of the diffusion model at step t.

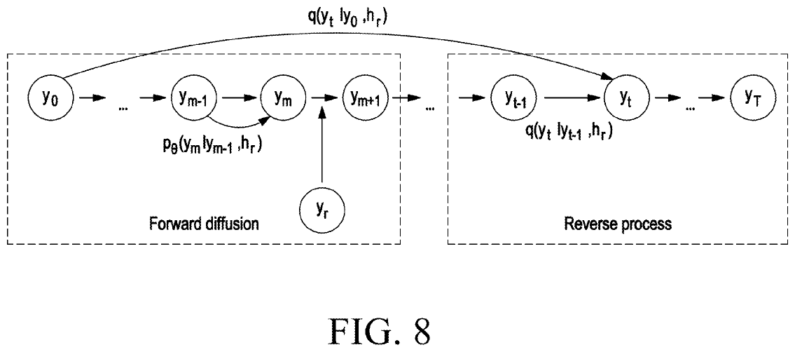

FIG. 8 illustrates a schematic diagram of diffusion model training and de-noising/de-interference processing according to an embodiment of the disclosure. The distribution corresponding to the signal y_{m,i} after adding noise interference (W_{I}ϵ_{I,θ}(y_{t,i}, h_{r,i}, m)+Wₙϵ_{θ}(y_{t,i}, h_{r,i}, m)) at step m in FIG. 8 may be represented by a distribution symbol, e.g. p_{θ}(y_{m,i}|y_{m,i-1}, hᵣ). In FIG. 8, the signal y denotes a signal of any one user. For example, yₘ denotes the user's signal after step m.

Here, the training process (forward diffusion process) of the noise interference term W_{I}ϵ_{I}+Wₙϵ is:

Method 1: Modelling Interference Distribution and Noise Distribution, respectively. The training process may include:
1) Determining IGDM input parameters: training data, parameter set {1, . . . , T} and αₜ, MCS, MU pairing information, MU pairing users' channels, user transmit power/SINR (or other information representing the user intensity proportion, e.g., adjustment format);
2) Obtaining MU pairing patterns, and calculating interference weights and channel patterns;
3) Determining whether the loss function has reached the threshold range;
4) If the threshold range is not reached, then:
randomly selecting y_{r,i} from the training data, and randomly selecting a parameter t from the parameter set;
obtaining h_{c,i}, and calculating hᵣ, W_{I,i}, W_{n,i};
randomly sampling to get ϵ_{I},ϵ~ [symbol] (0, I);
predicting noise and interference by the prediction module; and
updating the gradient values for the prediction module based on the above Equation 8 and the loss function.
5) If the threshold range is reached, stop the training and output ϵ_{I,θ}(y_{t,i}, h_{r,i}, t) and ϵ_{θ}(y_{t,i}, h_{r,i}, t).

Method 2: Unify the interference distribution and noise distribution into a single distribution

$${y}_{r , i , p} = \frac{1}{\sqrt{U + {σ}^{2}}} {W}_{s , i} * {x}_{r , i} + \frac{\sqrt{U - 1 + {σ}^{2}}}{\sqrt{U + {σ}^{2}}} {W}_{In , i} {ϵ}_{I , n}$$

for modeling, where

$${W}_{In , i} = 1 / \sqrt{( {W}_{I , i} + {W}_{n , i}^{2} )} and {ε}_{I , n}$$

are the normalized distributions corresponding to W_{I}ϵ_{I}+Wₙϵ. The modeling process may include:
1) Determining IGDM input parameters: training data, parameter set {1, . . . , T} and αₜ, MCS, MU pairing information, MU pairing users' channels, user transmit power/SINR (or other information representing the user intensity proportion, e.g., adjustment format);
2) Obtaining MU pairing patterns, and calculating interference weights and channel patterns;
3) Determining whether the loss function has reached the threshold range;
4) If the threshold range is not reached, then:
randomly selecting y_{r,i} from the training data, and randomly selecting a parameter t from the parameter set;
obtaining h_{c,i}, and calculating hᵣ, W_{I,i}, W_{n,i};
randomly sampling to get ϵ_{I}, ϵ~ [symbol] (0, I).
predicting noise and interference by the prediction module; and
updating the gradient values for the prediction module based on the above Equation 8 and the loss function.
5) If the threshold range is reached, stop the training and output ϵ_{I,n,θ}(y_{t,i}, h_{r,i}, t), and based on W_{I,i}, W_{n,i}, W_{In,i}, and ϵ_{I,n,θ}, ϵ_{I,θ}(y_{t,i}, h_{r,i}, t) and ϵ_{θ}(y_{t,i}, h_{r,i}, t) are obtained, where
ϵ_{I,θ}(y_{t,i}, h_{r,i}, t)=W_{I,i}*ϵ_{I,n,θ}(y_{t,i}, h_{r,i}, t)
ϵ_{θ}(y_{t,i}, h_{r,i}, t)=W_{n,i}*ϵ_{I,n,θ}(y_{t,i}, h_{r,i}, t)
W_{I,i}*ϵ_{I,θ}(y_{t,i}, h_{r,i}, t) for each step is summed, yielding the sensed interference term.

After obtaining noise and interference, the IGDM mitigates noise and interference through an inverse process.

The reverse process is:
a). Input parameters y_{r,i,p}, hᵣ and MCS, maximum step count m1;
b). Calculate the required number of steps m based on the MCS;
c) y_{m,i}=y_{r,i,p};
d). For t=m, . . . , 2

Calculate

$$d = \frac{\sqrt{U - 1 + {σ}^{2}}}{\sqrt{U + {σ}^{2}}} .$$

$${W}_{t , i} {ϵ}_{I , n , θ} ( {y}_{m , i} , {h}_{r , i} , t ) + \frac{\sqrt{U - 1 + {σ}^{2}}}{\sqrt{U + {σ}^{2}}} {W}_{n , i} {ϵ}_{θ} ( {y}_{m , i} , {h}_{r , i} , t ) or$$

$$d = {W}_{In , i} {ϵ}_{I , n} ( {y}_{m , i} , {h}_{r , i} , t ) ;$$

e). Calculate

$${y}_{t , i}^{w}$$

according to q states in the register:

$${y}_{t - 1 , i} = \sqrt{{α}_{t - 1}} \frac{{y}_{t , i}^{w} - \sqrt{1 - {α}_{t}} * d}{\sqrt{{α}_{t}}} + \sqrt{1 - {α}_{t - 1}} * d ;$$

f). End
g).

$$t = 1 , {y}_{0 , i} = {y}_{r , i} = \frac{{y}_{1 , i}^{w} - \sqrt{1 - {α}_{1}} * d}{\sqrt{{α}_{1}}}$$

Here, y_{r,i} is the data signal after noise and interference mitigation, of which quality is closer to the actual transmitted signal, mitigating the effect of interference and achieving greater accuracy.

d is a value obtained at each step in the process of diffusion model training. The training of the diffusion model involves incrementally adding noise to a noise-free signal. As shown in FIG. 8, each circle corresponds to one step, where a small amount of noise interference is added at each step until the final signal whose difference from the temporal interference noise distribution is less than the loss function is obtained. Then, in the reverse process, the noise interference in the received signal is gradually mitigated step by step.

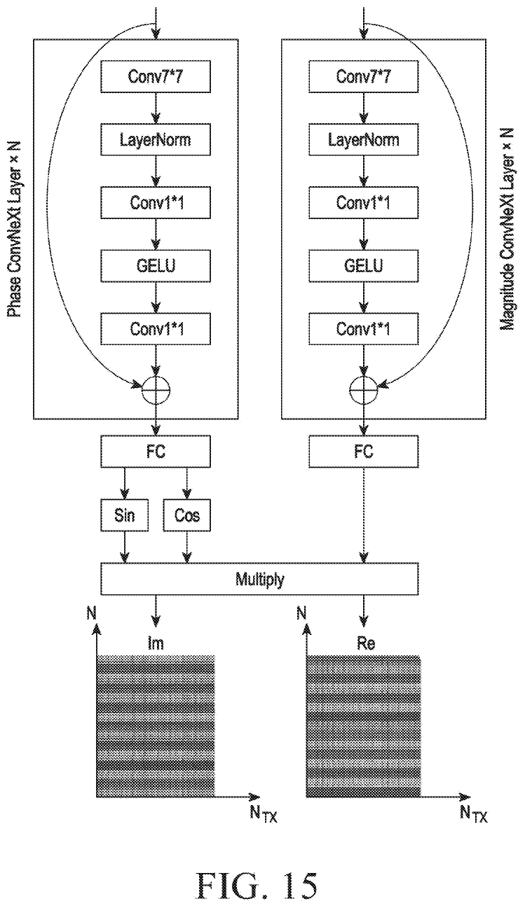

In the process of learning noise by the diffusion model, an AI model may either learn the real and imaginary parts of noise or may use two parallel models to separately learn the phase and amplitude, to be ultimately synthesized into complex noise. The model structure is as shown in FIG. 15.

FIG. 15 is a schematic diagram of a model structure for training a diffusion model according to an embodiment of the disclosure.

Another interference sensing method involves calculating the signal difference value Diff based on the output y_{r,i} and input y_{r,i,p} of the IGDM, where W_{I,i}*Diff is the sensed interference magnitude.

Based on y_{r,i}, SINR may be calculated to obtain performance parameters such as Tput, SE, and the like. If these performance parameters are better, the sensed interference magnitude or the remaining interference magnitude obtained based on the interference mitigation effectiveness is used for interference graph generation and BF design.

If the sensed interference magnitude is used, the BF objective is to optimize data after BF, improving the efficiency of subsequent interference mitigation. If the remaining interference magnitude is used, the BF objective is to further mitigate remaining interference while improving the processing efficiency of subsequent modules. For the resource coordination module, arbitrary interference represents the magnitude of mutual interference between users.

To effectively sense and mitigate interference, an embodiment of the disclosure proposes an IGDM system based on integrated IS and IM, which may be used to sense and mitigate interference not mitigated after MMSE equalization. IM processing is performed based on the designed IGDM to improve signal quality and anti-interference ability. The sensed interference is then determined based on the designed weights and IM results.

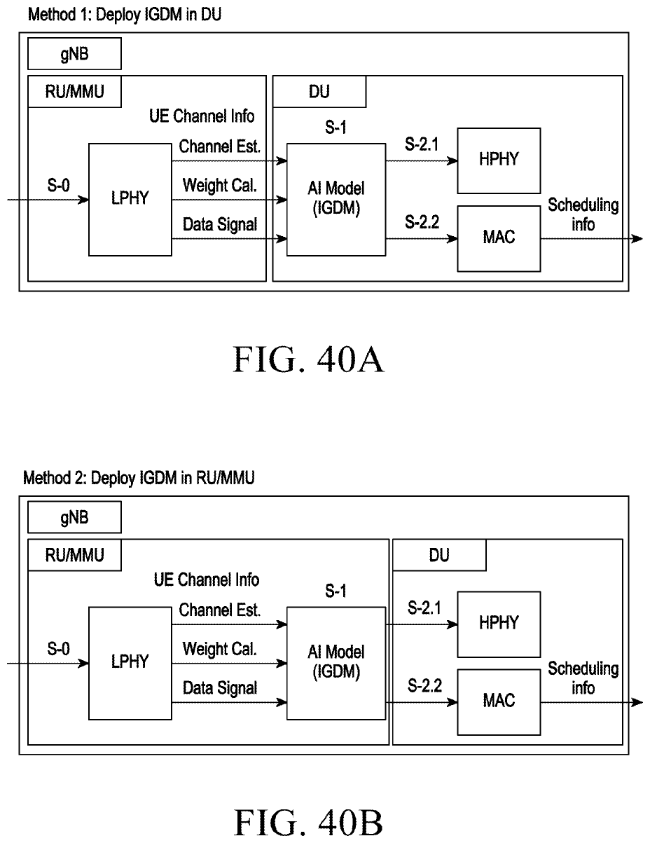

FIG. 40A is a schematic diagram of a deployment location of an IGDM on the network side according to an embodiment of the disclosure.

FIG. 40B is a schematic diagram of a deployment location of an IGDM on the network side according to an embodiment of the disclosure.

When deployed at the base station, the IGDM may be deployed in the data unit (DU) as shown in FIG. 40A, or may be deployed in the MMU as shown in FIG. 40B. The overall network-side operation flow after deployment is as follows: after receiving signals, the network obtains channel information and preprocessing weights (BF, MMSE), the AI model performs interference mitigation on them, and transmits the interference-mitigated signals to the demodulation and decoding module. Interference information is transmitted to the MAC for generation of the mutual interference effect graph, and selection of BF and a multiplexing user.

The solutions in the embodiments of the disclosure are described in detail below in conjunction with different application scenarios.

### Embodiment 1: Interference Mitigation Within Same Cell Coverage Area Based on Multi-User Multiplexing

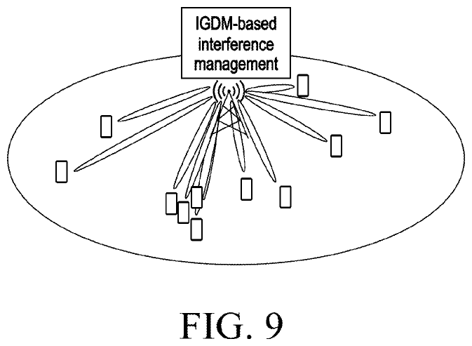

FIGS. 9, 10, and 11 are schematic diagrams of a deployment way of a solution according to various embodiments of the disclosure.

The IGDM-based interference management method proposed in the embodiments of the disclosure may be deployed on the network side of a cell (as shown in FIG. 9). The matching graph (which may be the mutual interference effect graph constructed hereinabove) generation module, interference mitigation effectiveness calculation module, IGDM interference sensing and mitigation module, BF based on the mutual interference effect graph, and resource coordination module based on the mutual interference effect graph (or interference mitigation effectiveness) are all deployed on the network side. The BF based on the mutual interference effect graph and the resource coordination module based on the mutual interference effect graph, which are optional modules, are selected based on whether interference-aware BF and resource coordination are required. The IGDM module may be placed after the processing of the received signal is completed on the network side, or may replace all or a part of the current modules.

Interference in a multi-user multiplexing system within the same cell coverage area originates from multiple users multiplexing the same resources. Multiple users simultaneously access the same access point which may be a same AP in a cell-free or a gNB in a MIMO system.

In some optional implementations, the IGDM module is placed after processing modules of the current communication system, and uses the BF based on the mutual interference graph and the resource coordination based on the mutual interference graph (or interference mitigation effectiveness).

In the above implementations, the interference management process may include:

Operation 1: Constructing the mutual interference effect graph.

Historical and current multiplexing user set information along with corresponding interference, performance, and channel feature information are obtained. Based on multiplexing user information and interference, the interference-multiplexing user relation graph is firstly obtained. The user nodes in the graph are constructed as multi-performance nodes. The current channel feature index is matched with the corresponding channel feature index of each performance node in the graph, and a mismatched performance node and corresponding lined thereof are deleted. If a performance node is an independent node, it is remained. Interference and performance between unpaired users are inferred based on user pairing relation to obtain more valid information.

Operation 2: Performing resource coordination and transmitting the coordinated resources to the UE side.

Based on the matched mutual interference effect graph or the calculated interference mitigation effectiveness, and the established optimization objective, the results of resource coordination, e.g., the multiplexing users and used resources, are obtained through optimization. The network side distributes the allocated resources to the users. The network side transmits the resources to the users, and the users then transmit signals to the network side on these resources.

Operation 3: The network side receiving the signals transmitted by the users and performing BF processing on them.

Optionally, the BF weights are adjusted based on the mutual interference effect graph. The BF weights are firstly calculated based on the estimated channel, and then the direction of the BF weights is adjusted according to interference effects between the users in the mutual interference effect graph.

Operation 4: Performing equalization on the BF-processed signal, and inputting the equalized signal to the IGDM module for interference mitigation and sensing.

Operation 5: Performing inverse interference mitigation on the input signal by the IGDM module based on the trained diffusion process, where the mitigated interference represents the sensed interference magnitude.

In this embodiment, the processing model used during the IGDM training is related to the model of modules through which the received signal passes. Since the signal passes through BF and equalization modules, diffusion weights when training needs to take into account both the BF weights and the equalization weights. Taking the MMSE equalization model as an example, the received signal of UE i undergoes BF processing with weights W_{bf,i}. The received signal after processing by the BF and equalization modules is:

$${y}_{eq , i} = \frac{{\vert {W}_{bf , i} {h}_{i} \vert}^{2} {x}_{i}}{{\vert {W}_{bf , i} {h}_{i} \vert}^{2} + 2 {σ}^{2}} + ( {\sum }_{{k = 1 : U}_{k \neq i}} \frac{{( {W}_{bf , i} {h}_{i} )}^{H} {W}_{bf , i} {h}_{k} {x}_{k}}{{\vert {W}_{bf , i} {h}_{i} \vert}^{2} + 2 {σ}^{2}} ) + \frac{{( {W}_{bf , i} {h}_{i} )}^{H}}{{\vert {W}_{bf , i} {h}_{i} \vert}^{2} + 2 {σ}^{2}} {W}_{bf , i} n ,$$

$$where , {W}_{s , i} = \frac{{\vert {W}_{bf , i} {h}_{c , i} \vert}^{2} {x}_{i}}{{\vert {W}_{bf , i} {h}_{c , i} \vert}^{2} + 2 {σ}^{2}}$$

$${W}_{l , i} = \frac{\vert {( {W}_{bf , i} {h}_{c , i} )}^{H} {W}_{bf , i} \vert}{{\vert {W}_{bf , i} {h}_{c , i} \vert}^{2} + 2 {σ}^{2}} * \frac{U - 1}{\sqrt{U - 1 + {σ}^{2}}}$$

$${W}_{n , i} = \frac{\vert {( {W}_{bf , i} {h}_{c , i} )}^{H} {W}_{bf , i} \vert}{{\vert {W}_{bf , i} {h}_{c , i} \vert}^{2} + 2 {σ}^{2}} * \frac{σ}{\sqrt{U - 1 + {σ}^{2}}}$$

When the equalization model employs zero-breaking or other models, the diffusion weights may be obtained according to zero-breaking or corresponding model processing.

In other optional implementations, considering that the IGDM module replaces all processing modules in the current communication system and resource coordination is based on the mutual interference graph (or interference mitigation effectiveness), then the interference management process may include:
Operation 1: Constructing the mutual interference effect graph;
Operation 2: Performing resource coordination based on the mutual interference effect graph or the calculated interference mitigation effectiveness;
Operation 3: Upon receiving a signal transmitted by a user on the network side, performing interference mitigation and sensing by the IGDM module.

It should be noted that if the IGDM module replaces all processing modules in the current communication system, the BF weights and the equalization weights may not be considered during the IGDM training, e.g., there is no W_{p,i}.

In some other optional implementations, considering that the IGDM module replaces certain modules of the current communication system, e.g., equalizer, and uses the BF based on the mutual interference graph and the resource coordination based on the mutual interference graph (or interference mitigation effectiveness), then the interference management process may include:
Operation1: Constructing the mutual interference effect graph;
Operation2: Performing resource coordination based on the mutual interference effect graph or the calculated interference mitigation effectiveness;
Operation3: Upon receiving a signal transmitted by a user on the network side, performing BF processing on it (adjusting the BF weights based on the mutual interference effect graph, with that BF processing the received signal);
Operation4: Inputting the BF-processed signal into the IGDM module for interference mitigation and sensing.

It should be noted that if the IGDM module replaces certain modules of the current communication system, e.g., equalizer, then only the BF weights are considered during the IGDM training, e.g.: W_{p,i}=W_{bf,i}.

### Embodiment 2: Interference Mitigation Within Different Cell Coverage Areas Based on Multi-User Multiplexing

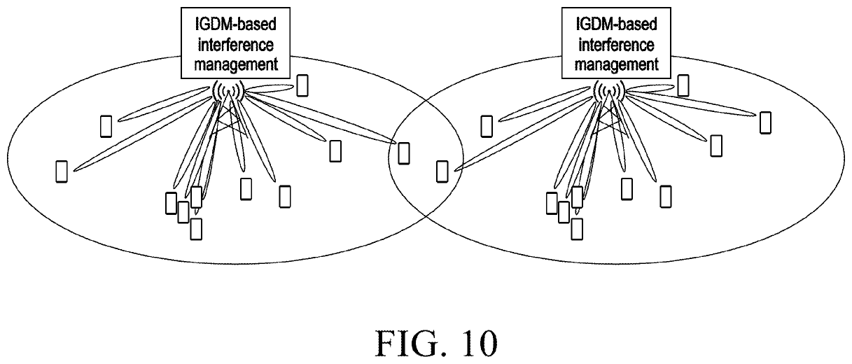

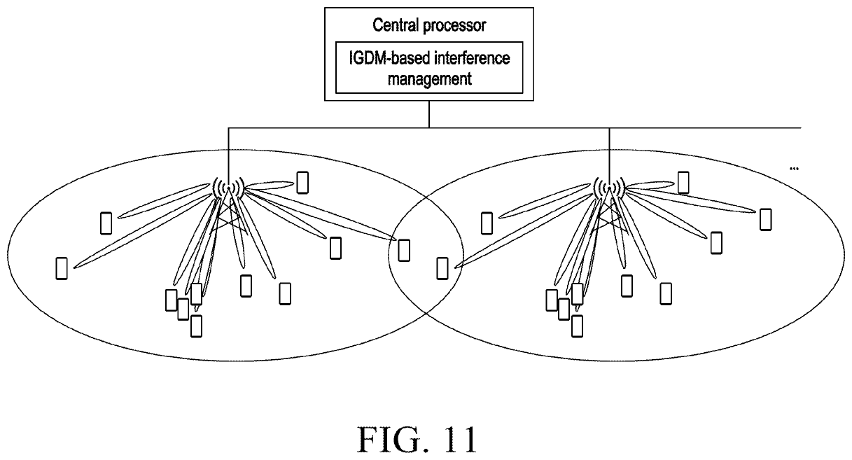

The IGDM-based interference management method proposed in the embodiments of the disclosure may be deployed on the network side of multiple cells (as shown in FIGS. 10 and 11). The matching graph (which may be the mutual interference effect graph constructed hereinabove) generation module, interference mitigation effectiveness calculation module, IGDM interference sensing and mitigation module, BF based on the mutual interference effect graph, and resource coordination module based on the mutual interference effect graph (or interference mitigation effectiveness) are all deployed on the network side. The BF based on the mutual interference effect graph and the resource coordination module based on the mutual interference effect graph (or interference mitigation effectiveness), which are optional modules (e.g., the BF processing and resource coordination on the signal may be implemented using existing methods), are selected based on whether interference-aware BF and resource coordination are required. The IGDM module may be placed after the modules that process the received signal on the network side, or may replace all or a part of the current modules.

Interference in a multi-user multiplexing system within the different cell coverage areas originates from multiple users accessing to different access points multiplexing the same resource(s). Alternatively, it originates from multiple users accessing the same access point multiplexing the same resource(s). Multiple users simultaneously access the same access point, which may be a same AP in a cell-free or a gNB in a MIMO system.

As compared to Embodiment 1, Embodiment 2 differs only in deployment modes, and the interference management process remains unchanged, that is, each network side performs the interference management process in Embodiment 1.

### Embodiment 3: Interference Mitigation on the UE Side with Strong Processing Capability

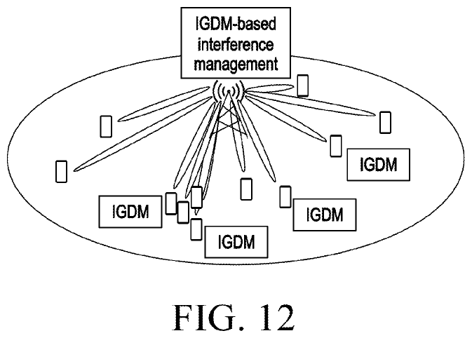

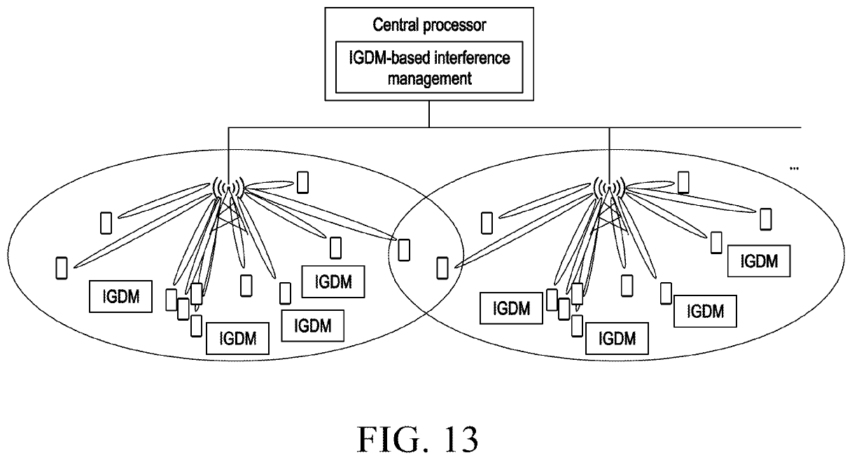

FIGS. 12 and 13 are schematic diagrams of a deployment way of another solution according to various embodiments of the disclosure.

The IGDM-based interference management method proposed in the embodiments of the disclosure may be deployed simultaneously on the network side and on the UE side with strong processing capacity (as shown in FIG. 12 or FIG. 13). The matching graph generation module, interference mitigation effectiveness calculation module, and IGDM interference sensing and mitigation module are deployed on the network side for processing interference in the received user signals, or deployed on the UE side with strong processing capacity for processing interference in signals received by the UE.

Optionally, when processing data transmitted by the UE-side on the network side, the BF based on the mutual interference effect graph and the resource coordination module based on the mutual interference effect graph (or interference mitigation effectiveness) are deployed on the network side.

Optionally, when processing data transmitted by the network-side on the UE side, the BF based on the mutual interference effect graph and the resource coordination module based on the mutual interference effect graph (or interference mitigation effectiveness) are deployed on the network side. (It should be noted that signals transmitted by the network side are those processed by the BF based on the mutual interference effect graph and transmitted on resources coordinated by the resource coordination module based on the mutual interference effect graph).

In the above embodiments, the BF based on the mutual interference effect graph and the resource coordination module based on the mutual interference effect graph (or interference mitigation effectiveness), which are optional modules, may be selected based on whether interference-aware BF and resource coordination are required.

Optionally, the IGDM module may be placed after the modules that process the received signal on the network side, or may replace all or a part of the current modules.

Optionally, the deployment on the network side is not limited to same-cell or multi-cell coverage scenarios.

When the IGDM is deployed on the network side, the interference management process may refer to relevant description in Embodiment 1 and is not repeated in detail herein.

When the IGDM is deployed on the UE side, the interference management process may include:

Operation1: Distributing the trained IGDM model to the UE side by the network side.

Operation2: Running the IGDM by the UE side for interference mitigation and sensing, and reporting the obtained UE side performance and interference magnitude to the network side. The performance may be reported directly through processed reference signals. The interference magnitude is obtained by utilizing signal mutuality. When the signals lack mutuality, the interference magnitude may be reported as a data signal on the physical uplink shared channel (PUSCH) channel.

Operation3: Upon receiving performance and interference on the network side, constructing a mutual interference effect graph matching channel feature.

Operation4: Performing resource coordination by the network side based on the graph, and selecting multiplexing resources for allocation corresponding to the optimal target.

Operation5: Designing BF weights for respective users based on the mutual interference effect graph and the resource coordination results.

Operation6: Transmitting the transmitted signal to the UE on the coordinated resources after passing through the BF module.

Operation7: Performing IGDM interference mitigation and sensing after receiving the signal on the UE side.

In Operation7, performance may be continuously obtained, interference is sensed, and the performance and the interference are reported to the network side, and then operations 3, 4, 5, and 6 are performed to iteratively update the graph, calculate the interference mitigation effectiveness, and optimize the BF weights and resource coordination.

### Embodiment 4: Interference Mitigation Scheme Deployed on the Network Side for IGDM Only

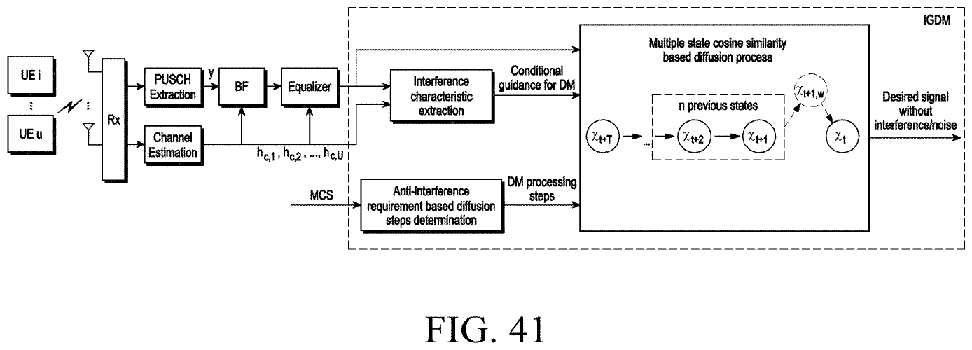

This embodiment involves only IGDM interference mitigation processing. The communication system architecture is as shown in FIG. 41.

FIG. 41 is a structural schematic diagram of an IGDM interference mitigation communication system according to an embodiment of the disclosure.

At the receive terminal, signals undergo BF and MMSE equalization processing and then undergo IGDM interference mitigation, wherein IGDM may include a condition-guided DM processing module based on interference characteristics, a diffusion processing module based on multiple-state cosine similarity, and a diffusion step decision module based on anti-interference requirements. These three modules are consistent with condition-guided DM processing, diffusion model processing steps based on anti-interference requirements, and multiple-state diffusion processing based on cosine similarity described above. However, the specific parameters and calculation methods employed in a portion of the solution are different. Here, the condition-guided DM processing considers interference intensity and angular characteristics to guide the DM to accurately decouple target user signals from interference user signals, thereby improving interference mitigation quality. The diffusion model processing based on multiple-state cosine similarity is used to eliminate fluctuations during the DM multi-step processing, enhancing accuracy and stability and improving the robustness of interference prediction. The diffusion model step decision module based on anti-interference requirements utilizes different MCS to characterize anti-interference capability, and determines the required number of steps of the diffusion model based on the MCS level, thereby reducing the number of steps of the diffusion model and improving the efficiency and applicability of the IGDM model.

Assuming that U users respectively transmit signals at power

$$\sqrt{{P}_{i}} , E [ {\vert {x}_{i}^{c} \vert}^{2} ] \leq 1.$$

The received signal after MMSE processing is:

$${y}_{eq , i}^{c} = G ( {h}_{i}^{c} \sqrt{{P}_{i}} {x}_{i}^{c} + {\sum }_{j} {h}_{j}^{c} \sqrt{{P}_{j}} {x}_{j}^{c} + {n}^{c} )$$

G is an MMSE matrix,

$$G = \sqrt{{P}_{i}} {( {h}_{i}^{c} )}^{H} {( {HPH}^{H} + 2 {σ}_{n}^{2} {I}_{n} )}^{- 1} . The real - valued {y}_{eq , i}^{c}$$

is represented by

$${y}_{i} , and {y}_{i} {W}_{s} \sqrt{{P}_{i}} {x}_{i} + {W}_{I} {\sum }_{j} {h}_{j} \sqrt{{P}_{j}} {x}_{j} + {W}_{n} n .$$

$$Define \text{?} = diag [ \begin{matrix}\vert {h}_{i}^{c} \vert \\ \vert {h}_{i}^{c} \vert\end{matrix} ] , \text{?} = diag ( Re ( {h}_{i}^{c} ) ) ,$$

$$\text{?} = diag ( Im ( {h}_{i}^{c} ) ) , \tilde{H} = [ \begin{matrix}{HPH}^{H} \\ {HPH}^{H}\end{matrix} ]$$

$${W}_{s} = {Gh}_{i}^{c} , {W}_{I} = \sqrt{{P}_{i}} [ \begin{matrix}\text{?} & \text{?} \\ \text{?} & \text{?}\end{matrix} ] {( \tilde{H} + 2 {σ}_{n}^{2} I )}^{- 1} ,$$

$${W}_{n} = \sqrt{{P}_{i}} \text{?} {( \tilde{H} + 2 {σ}_{n}^{2} I )}^{- 1} , P = diag ( {P}_{1} , … {P}_{U} ) , I ∈ {R}^{2 {N}_{rx} \times 1} .$$

Then, the normalized real-valued signal distribution is:

$$p ( {y}_{i} \vert {x}_{i} ) ∼ N ( {y}_{i} ; \frac{\sqrt{{P}_{i}}}{\sqrt{{P}_{i} + {\sum }_{j} {P}_{j} + {σ}_{n}^{2}}} {W}_{S} {x}_{i} , \frac{{\sum }_{j} {P}_{j}}{{P}_{i} + {\sum }_{j} {P}_{j} + {σ}_{n}^{2}} {W}_{I}^{2} + \frac{{σ}_{n}^{2}}{{P}_{i} + {\sum }_{j} {P}_{j} + {σ}_{n}^{2}} {W}_{n}^{2} )$$

By MMSE equalization and normalization, yᵢ may be written as:

$${y}_{i} = \frac{\sqrt{{P}_{i}}}{\sqrt{{P}_{i} + {\sum }_{j} {P}_{j} + {σ}_{n}^{2}}} {W}_{s} {x}_{i} + \frac{{\sum }_{j} {P}_{j}}{\sqrt{{P}_{i} + {\sum }_{j} {P}_{j} + {σ}_{n}^{2}}} {W}_{I} {ϵ}_{I} + \frac{{σ}_{n}^{2}}{\sqrt{{P}_{i} + {\sum }_{j} {P}_{j} + {σ}_{n}^{2}}} {W}_{n} ϵ$$

$$where {ϵ}_{I} , ϵ ∼ N ( 0 , I ) ∘$$

The objective of IGDM is to learn the distribution of Wₛ\sqrt{Pᵢ}xᵢ through training, and utilize sampling algorithms to mitigate interference and noise to recover Wₛ\sqrt{Pᵢ}xᵢ.

Firstly, the interference characteristics based conditional DM extracts interference characteristics, specifically interference intensity characteristics and interference angle characteristics. Since the channels for user signals and interference signals are correlated, the determined channel for each MU UE may be obtained by reference signals, e.g., the estimated channel. The intensity of UE i may be calculated based on the estimated channel |h_{c,i}| and transmit power intensity Pᵢ, e.g. the received signal intensity Pᵢ|h_{c,i}|². However, signals from multiple users (MUs) are superimposed together. Therefore, a normalized intensity proportion is used to evaluate the intensity proportion of each user in the mixed signal, providing intensity information for learning interference signals in DM processing. The intensity proportion is defined as an intensity weight:

$${W}_{inf , i} = \frac{{P}_{i} {\vert {h}_{c , i} \vert}^{2}}{{\sum }_{j = 1 , … , U} {P}_{j} {\vert {h}_{c , j} \vert}^{2}}$$

The interference angle characteristic θ results from the complex channel h_{c,i}. The angle characteristics may be directly defined as the angles of channels of each MU pairing UE.

The signals from MU pairing UEs interfere with each other. The intensity and angle characteristics of all MU users may be used to distinguish interference from user signals. Therefore, W_{inf,i} and h_{c,i} of all pairing users are regarded as conditions to guide DM training, resulting in accurate interference mitigation results. In the inverse diffusion processing, the received signal after preprocessing (BF, MMSE), W_{inf,i} and h_{c,i} are input together to the DM model for interference mitigation. The conditional distribution is p(yᵢ|x₀, H, W_{inf})=p(yᵢ|x₀, h_{c,1}, . . . , h_{c,U}, W_{inf,1}, . . . , W_{inf,U}).

In traditional DM model, each step predicts and mitigates noise based on the output of previous step. The deviation of processing at each step will be accumulated, and ultimately cause a larger deviation between the predicted signal distribution and the actual correct distribution. Therefore, a diffusion processing method based on multiple-state cosine similarity is proposed. In this method, the diffusion probability distribution considers n historical states, and calculates the cosine similarity weighted average y_{w,t+1} of these n states as the state distribution for step t+1, e.g., y_{w,t+1}=F(yₜ₊₁, . . . , yₜ₊ₙ). Here, F(·) is the weighted average-cosine similarity. Let CS(·) denote the cosine similarity, then

$$F ( {y}_{t + 1} , … , {y}_{t + n} ) = \frac{{\sum }_{i = 2}^{n} {y}_{t + 1} * CS ( ( {y}_{( t + 1 )} - {y}_{( t + n )} ) , ( {y}_{t + i} - {y}_{( t + i + 1 )} ) )}{n - 1} .$$

$$Here , {y}_{t + 1} ∼ N ( 0 , {σ}_{t + i}^{2} ) ,$$

and each state is an independent sampling process. For simplicity, let

$$\sum {W}_{cs} denote {\sum }_{i = 2}^{n} CS ( ( {y}_{( t + 1 )} - {y}_{( t + n )} ) , ( {y}_{t + i} - {y}_{( t + i + 1 )} ) ) , then :$$

$$F ( {y}_{t + 1} , {y}_{t + 2} … {y}_{t + n} ) ∼ N ( 0 , \frac{\sum {W}_{CS}^{2} {\hat{σ}}_{t + i}^{2}}{{( n - 1 )}^{2}} ) = N ( 0 , \frac{\sum {W}_{CS}^{2} ( {σ}_{t + i}^{2} + {ε}_{t + i}^{2} )}{{( n - 1 )}^{2}} )$$

$$where {\hat{σ}}_{t + i}^{2}$$

is the variance of the predicted distribution under the state

$$t + i , {\hat{σ}}_{t + i}^{2} = {σ}_{t + i}^{2} + {ε}_{t + i}^{2} , and {ε}_{t + i}$$

is the prediction deviation. The corresponding weighted average distribution is:

$$\hat{p} ( {y}_{t} \vert {x}_{0} , H , {W}_{inf} ) = \frac{\sum {W}_{cs} \hat{p} ( {y}_{t + 1} \vert {x}_{0} , H , {W}_{inf} )}{n - 1}$$

\hat{p} denotes the probability distribution predicted during DM sampling. Due to the inference loss of the AI model, \hat{p} exhibits a deviation from the actual distribution p. The loss of the AI model follows a Gaussian distribution with standard deviation, e.g., εₜ₊ᵢ~N(0, L) Considering multiple states, weighted averaged should be conducted. The cosine similarity based weighted averaging takes into account the vector characteristics of complex signals, enabling capture the characteristics of the complex signals. Additionally, a register is used to store n historical states, where n>2. The principal vector directions for the n historical states are defined as Vₘₐᵢₙ=yₜ₊₁−yₜ₊ₙ, and the vector direction of each historical state is Vₜ₊ᵢ=yₜ₊ᵢ−yₜ₊ᵢ₊₁. The cosine similarity is:

$$CS ( {V}_{main} , {V}_{t + i} ) = \frac{{V}_{main} * {V}_{t + i}}{\vert {V}_{main} \vert \vert {V}_{t + i} \vert}$$

$$CS ( {V}_{main} , {V}_{t + i} )$$

is used as weight to obtain the weighted average state of the previous n states, and the weighted average state is used as the previous state for the t-th state to perform DM sampling to obtain yₜ, as shown in FIG. 43.

FIG. 43 is a schematic diagram of a process of multiple-state-based diffusion processing according to an embodiment of the disclosure.

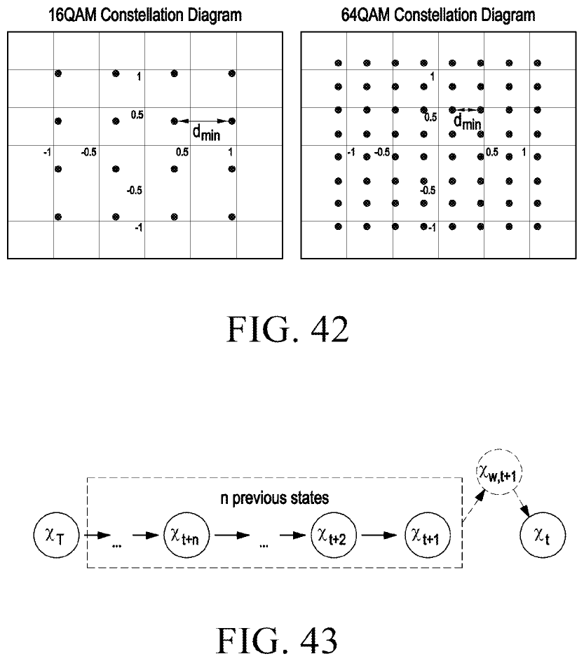

However, since the DM is an iterative process requiring numerous steps to obtain the final result, this process involves high computational complexity. To reduce complexity, a method for reducing the number of steps based on anti-interference requirements is proposed. Firstly, the MCS of the UE determines its modulation order (QPSK, 16QAM, 64QAM, etc.). Different modulation orders require distinct soft decision areas. That is, the areas determining that a symbol corresponds to a corresponding modulation constellation point are different. The minimum distance between adjacent constellation points in the constellation diagram is defined as dₘᵢₙ The smaller the modulation order is, the larger the dₘᵢₙ is, as shown in FIG. 42.

FIG. 42 is a schematic diagram of distance between constellation points for different modulation orders according to an embodiment of the disclosure.

In the process of interference mitigation, when a result of a certain step falls within the soft decision area, a symbol is determined as corresponding constellation point. A larger soft decision area permits greater interference mitigation error, that is, requirements for the accuracy of interference mitigation are low and user requirements for anti-interference is low. The IGDM may achieve satisfactory results with fewer steps, without high-precision interference mitigation. The operational decision deviation is defined as:

$${ρ}_{i} \leq \frac{1}{2} * {( \frac{{d}_{min}}{2} )}^{2}$$

where ρᵢ is used to evaluate deviation of the real and imaginary parts from the actual constellation point, and ρᵢ represents variance values. dₘᵢₙ/2 is half the minimum distance between constellation point, e.g., the decision area. To ensure the accuracy of interference mitigation, the Kullback-Leibler (KL) divergence between the signal distribution obtained at the m-th step of DM processing and the actual distribution is less than the threshold-allowed deviation σ.

$$KL ( q ( {y}_{m} \vert y , H , {W}_{inf} ) ‖ p ( {y}_{0} \vert y , H ) ) \leq σ$$

$$Here , σ < log \frac{{σ}_{0}^{2}}{{σ}_{0}^{2} + {ρ}_{i}} + \frac{{σ}_{0}^{2} + {ρ}_{i}}{{σ}_{0}^{2}} - 1 , and {σ}_{0}^{2}$$

denotes the variance of the original transmitted signal distribution under a fixed MCS. When ρᵢ is smaller, σ is smaller, requiring more precise IGDM de-noising and a greater number of DM steps. Therefore, considering anti-interference requirements for different users, users may be categorized into C classes based on MCS, with each class having the same modulation level, and applying corresponding number of steps for de-noising to avoid additional precision loss introduced by excessive or insufficient de-noising.

Finally, the signal after de-interference is obtained through the training and inversion processes of IGDM.

Based on the general diffusion model formula, the initial transmitted signal is y₀=Wₛ\sqrt{Pᵢ}yᵢ. For user i, the DM model is:

$${y}_{t} = \sqrt{\overline{{α}_{t}}} {y}_{0} - \sqrt{1 - \overline{{α}_{t}}} ( {\sum }_{j} \sqrt{{P}_{j}} {W}_{I} {ϵ}_{I} + {σ}_{n} {W}_{n} ϵ )$$

$${\overline{a}}_{t} = \frac{{P}_{i}}{{P}_{i} + {\sum }_{j} {P}_{j} + {σ}_{n}^{2}} ,$$

and it is assumed that ϵ_{θ,I}, ϵ_{θ} are estimated ϵ_{I}, ϵ at step t. The objective of IGDM training is to minimize the following loss function:

$${𝔼}_{{y}_{0} , {ϵ}_{I} , ϵ} ( {‖ ( \frac{{\sum }_{j} \sqrt{{P}_{j}}}{\sqrt{{P}_{i} + {\sum }_{j} {P}_{j} + {σ}_{n}^{2}}} {W}_{I} {ϵ}_{I} + \frac{{σ}_{n}}{\sqrt{{P}_{i} + {\sum }_{j} {P}_{j} + {σ}_{n}^{2}}} {W}_{n} ϵ ) - ( \frac{{\sum }_{j} \sqrt{{P}_{j}}}{\sqrt{{P}_{i} + {\sum }_{j} {P}_{j} + {σ}_{n}^{2}}} {W}_{I} {ϵ}_{θ , I} + \frac{{σ}_{n}}{\sqrt{{P}_{i} + {\sum }_{j} {P}_{j} + {σ}_{n}^{2}}} {W}_{n} {ϵ}_{θ} ) ‖}_{2}^{2} )$$

Considering the factors, the loss function may be re-written as:

$${𝔼}_{{y}_{0} , {ϵ}_{I} , ϵ} ( {‖ ( {\sum }_{j} \sqrt{{P}_{j}} {W}_{I} {ϵ}_{I} + {σ}_{n} {W}_{n} ϵ ) - ( {\sum }_{j} \sqrt{{P}_{j}} {W}_{I} {ϵ}_{θ , I} + {σ}_{n} {W}_{n} {ϵ}_{θ} ) ‖}_{2}^{2}$$

The training process algorithm is:

Information input into the model may include: a training set, a hyperparameter T, α̅ₜ̅, and MCS, P, H, U,

$$2 {σ}_{n}^{2} ,$$

### SINR.

1. If the KL divergence is not less than σ, repeat steps 2-5;
2. Randomly sample signals yᵢ and T from the training set and {1, 2, . . . , T};
3. Obtain

$${{H}_{x}}^{︶} , {{H}_{x}^{r}}^{︶} , {{H}_{x}^{I}}^{︶} , \tilde{H} , P , 2 {σ}_{n}^{2} ,$$

and calculate Wₛ, W_{I}, Wₙ;
4. Randomly sample ϵ_{I}, ϵ~N(0, I);
5. Calculate a gradient:

$${∇}_{θ} ( {‖ ( {\sum }_{j} \sqrt{{P}_{j}} {W}_{I} {ϵ}_{I} + {σ}_{n} {W}_{n} ϵ ) - ( {\sum }_{j} \sqrt{{P}_{j}} {W}_{I} {ϵ}_{θ , I} + {σ}_{n} {W}_{n} {ϵ}_{θ} ) ‖}_{2}^{2} ) ;$$

6. Output the trained IGDM after satisfying conditions.

For the reverse process, the output at step t is:

$${y}_{t} = \sqrt{\overline{{α}_{t}}} ( \frac{1}{\sqrt{\overline{{α}_{t + 1}}}} ( {y}_{w , t + 1} - \sqrt{1 - \overline{{α}_{t + 1}}} ( {\sum }_{j} \sqrt{{P}_{j}} {W}_{I} {ϵ}_{θ , I} + {σ}_{n} {W}_{n} {ϵ}_{θ} ) ) ) + \sqrt{1 - \overline{{α}_{t + 1}}} ( {\sum }_{j} \sqrt{{P}_{j}} {W}_{I} {ϵ}_{θ , I} + {σ}_{n} {W}_{n} {ϵ}_{θ} )$$

The reverse process outputs the interference mitigation result at the final step1. In sampling, the number of steps is determined based on MCS, and for each step, the information of its previous step is obtained by weighted averaging. The specific reverse processing algorithm is:

The input information is: values of the previous n states for each state t, n, and corresponding cosine similarity thereof, processed received signal yᵢ, MCS, P, H, U,

$$2 {σ}_{n}^{2} ;$$

### SINR.

1. Obtain the modulation format, and calculate the number of steps m;
2. The m-th step state yₘ=yₜ;
3. For t=m, . . . , 2;
4. Calculate y_{w,t+1};
5.

$${y}_{t} = \sqrt{\overline{{α}_{t}}} ( \frac{1}{\sqrt{\overline{{α}_{t + 1}}}} ( {y}_{w , t + 1} - \sqrt{1 - \overline{{α}_{t + 1}}} ( {\sum }_{j} \sqrt{{P}_{j}} {W}_{I} {ϵ}_{θ , I} + {σ}_{n} {W}_{n} {ϵ}_{θ} ) ) ) + \sqrt{1 - \overline{{α}_{t}}} ( {\sum }_{j} \sqrt{{P}_{j}} {W}_{I} {ϵ}_{θ , I} + {σ}_{n} {W}_{n} {ϵ}_{θ} )$$

6. End for

$$t = 1 , {y}_{i}^{′} = \frac{1}{\sqrt{\overline{{α}_{1}}}} ( {y}_{w , 1} - \sqrt{1 - \overline{{α}_{1}}} ( {\sum }_{j} \sqrt{{P}_{j}} {W}_{I} {ϵ}_{θ , I} + {σ}_{n} {W}_{n} {ϵ}_{θ} ) )$$

is the output interference mitigation result.

To ensure the latency requirement in communication, the diffusion model may further be distilled to reduce processing complexity and latency thereof. Specific distillation or knowledge transfer methods include but are not limited to those shown in FIG. 37. The effects after the distillation include a reduction in the number of parameters of the model itself, a decrease in the number of diffusion steps, and a reduction in processing time.

An embodiment of the disclosure also provides an electronic device comprising a processor, and optionally further comprising a transceiver and/or memory coupled to the processor, the processor being configured to perform the steps of the method according to any optional embodiment of the disclosure.

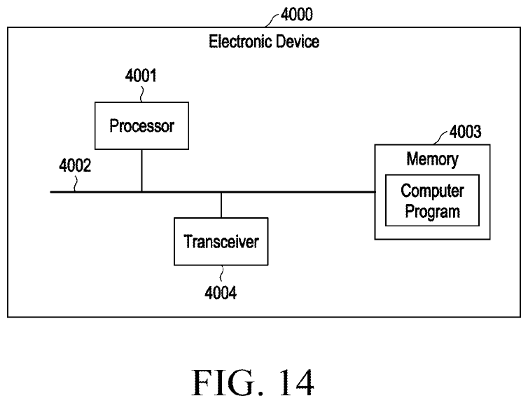

FIG. 14 shows a schematic structure diagram of an electronic device according to an embodiment of the disclosure.

Referring to FIG. 14, the electronic device 4000 shown in FIG. 14 may include a processor 4001 and memory 4003. The processor 4001 is connected to the memory 4003, for example, through a bus 4002. Optionally, the electronic device 4000 may further include a transceiver 4004 that may be used for data exchange, for example, transmission and reception of data, between the electronic device and other electronic device. It should be noted that, in practical applications, the number of transceivers 4004 is not limited to one, and the structure of the electronic device 4000 does not constitute any limitations to the embodiments of the disclosure. Optionally, the electronic device may be a first network node, a second network node or a third network node.

The processor 4001 may be a central processing unit (CPU), a general-purpose processor, a digital signal processor (DSP), an application specific integrated circuit (ASIC), or a field programmable gate array (FPGA), or other programmable logic devices, transistor logic devices, hardware components, or any combination thereof. It may implement or execute various logical blocks, modules and circuits described in connection with the disclosure. The processor 4001 may also be a combination for realizing computing functions, for example, a combination of one or more microprocessors, a combination of a DSP and a microprocessor, etc.

The bus 4002 may include a path to transfer information between the components described above. The bus 4002 may be a peripheral component interconnect (PCI) bus, or an extended industry standard architecture (EISA) bus, etc. The bus 4002 may be an address bus, a data bus, a control bus, etc. For ease of presentation, the bus is represented by only one thick line in FIG. 14. However, it does not mean that there is only one bus or one type of buses.

The memory 4003 may be, but not limited to, read only memories (ROMs) or other types of static storage devices that may store static information and instructions, random access memories (RAMs) or other types of dynamic storage devices that may store information and instructions, may be electrically erasable programmable read only memories (EEPROMs), compact disc read only memories (CD-ROMs) or other optical disk storages, optical disc storages (including compact discs, laser discs, discs, digital versatile discs, blue-ray discs, etc.), magnetic storage media or other magnetic storage devices, or any other media that may carry or store computer program and may be accessed by computers.

The memory 4003 is used to store computer program for executing the solutions of the disclosure, and is controlled by the processor 4001. The processor 4001 is used to execute the computer program stored in the memory 4003 to implement the solution provided in any method embodiment described above.

Embodiments of the disclosure provide a computer-readable storage medium having a computer program stored thereon, the computer program, when executed by a processor, implements the steps and corresponding contents of the foregoing method embodiments.

Embodiments of the disclosure also provide a computer program product including a computer program, the computer program when executed by a processor realizing the steps and corresponding contents of the preceding method embodiments.

The terms “first”, “second”, “third”, “fourth”, “1”, “2”, etc. (if present) in the specification and claims of this disclosure and the accompanying drawings above are used to distinguish similar objects and need not be used to describe a particular order or sequence. It should be understood that the data so used is interchangeable where appropriate so that embodiments of the disclosure described herein may be implemented in an order other than that illustrated or described in the text.

It should be understood that while the flow diagrams of embodiments of the disclosure indicate the individual operational steps by arrows, the order in which these steps are performed is not limited to the order indicated by the arrows. Unless explicitly stated herein, in some implementation scenarios of embodiments of the disclosure, the implementation steps in the respective flowcharts may be performed in other orders as desired. In addition, some, or all of the steps in each flowchart may include multiple sub-steps or multiple phases based on the actual implementation scenario. Some or all of these sub-steps or stages may be executed at the same moment, and each of these sub-steps or stages may also be executed at different moments separately. The order of execution of these sub-steps or stages may be flexibly configured according to requirements in different scenarios of execution time, and the embodiments of the disclosure are not limited thereto.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a network node in a wireless communication network, the method comprising:
determining, by the network node, interference-related information corresponding to a first multiplexing (MU) user equipment (UE) based on first information of the first MU UE and a second MU UE, wherein the second MU UE and the first MU UE are configured to perform MU multiple input and multiple output (MIMO) multiplexing transmission, and wherein the first information includes at least one of MU pairing information, signal intensity-related information, or channel-related information; and
performing, by the network node, interference mitigation processing on a signal transmitted by the first MU UE by using a first neural network, based on the interference-related information corresponding to the first MU UE.

2. The method of claim 1, wherein the interference-related information corresponding to the first MU UE includes at least one of:
interference weight information indicating an interference intensity from the second MU UE to the first MU UE on each frequency-domain resource; or
interference channel information indicating an interference channel from the second MU UE to the first MU UE on each frequency-domain resource.

3. The method of claim 2, wherein the determining of the interference-related information corresponding to the first MU UE, comprises at least one of:
determining the interference weight information corresponding to the first MU UE based on the MU pairing information and the signal intensity-related information; or
determining the interference channel information corresponding to the first MU UE based on the MU pairing information and the channel-related information.

4. The method of claim 1,
wherein the first neural network includes a diffusion network, and
wherein the performing of the interference mitigation processing on the signal transmitted by the first MU UE by using the first neural network, comprises:
determining a number of processing steps for interference mitigation by the diffusion network; and
performing the interference mitigation processing on the signal transmitted by the first MU UE by using the first neural network, based on the determined number of processing steps.

5. The method of claim 4, wherein the determining of the number of processing steps for the interference mitigation by the diffusion network, comprises:
determining a maximum number of steps for the interference mitigation by the diffusion network using a second neural network based on environmental information of the first MU UE; and
determining the number of processing steps for the interference mitigation by the diffusion network based on the maximum number of steps and the signal intensity-related information of the first MU UE.

6. The method of claim 4,
wherein the performing of the interference mitigation processing on the signal transmitted by the first MU UE by using the first neural network, further comprises:
iteratively performing T times of the interference mitigation processing;
wherein T is the determined number of processing steps.

7. The method of claim 6,
wherein a t-th interference mitigation processing in the T times of the interference mitigation processing comprises:
determining historical interference mitigation processing results;
weighting the historical interference mitigation processing results;
predicting an interference for the first MU UE based on a weighted result of (t−1)-th interference mitigation processing and the interference-related information corresponding to the first MU UE; and
performing the t-th interference mitigation processing based on the predicted interference.

8. The method of claim 1,
wherein the signal intensity-related information includes at least one of a modulation and coding scheme (MCS) or a signal to interference plus noise ratio (SINR), and
wherein the channel-related information includes channel estimation results of UEs.

9. The method of claim 4, wherein the determining of the number of processing steps for the interference mitigation by the diffusion network, comprises:
identifying a modulation format in the signal intensity-related information;
based on the identified modulation format, determining a modulation order of the modulation format; and
based on the determined modulation order, determining a soft-decision area of the modulation order.

10. The method of claim 9, wherein the modulation format includes one of quadrature phase-shift keying (QPSK), 16-quadrature amplitude modulation, 64-quadrature amplitude modulation, 256-quadrature amplitude modulation, or 1024-quadrature amplitude modulation.

11. An electronic device, comprising:
memory, comprising one or more storage media, storing one or more computer programs; and
one or more processors communicatively coupled to the memory,
wherein the one or more computer programs include computer-executable instructions that, when executed by the one or more processors individually or collectively, cause the electronic device to:
determine interference-related information corresponding to a first multiplexing (MU) user equipment (UE) based on first information of the first MU UE and a second MU UE, wherein the second MU UE and the first MU UE are configured to perform MU multiple input and multiple output (MIMO) multiplexing transmission, and wherein the first information includes at least one of MU pairing information, signal intensity-related information, or channel-related information, and
perform interference mitigation processing on a signal transmitted by the first MU UE by using a first neural network, based on the interference-related information corresponding to the first MU UE.

12. The electronic device of claim 11, wherein the interference-related information corresponding to the first MU UE includes at least one of:
interference weight information indicating an interference intensity from the second MU UE to the first MU UE on each frequency-domain resource; or
interference channel information indicating an interference channel from the second MU UE to the first MU UE on each frequency-domain resource.

13. The electronic device of claim 12, wherein, to determine of the interference-related information corresponding to the first MU UE, the one or more computer programs include computer-executable instructions that, when executed by the one or more processors individually or collectively, cause the electronic device to at least one of:
determine the interference weight information corresponding to the first MU UE based on the MU pairing information and the signal intensity-related information; or
determine the interference channel information corresponding to the first MU UE based on the MU pairing information and the channel-related information.

14. The electronic device of claim 11,
wherein the first neural network includes a diffusion network, and
wherein, to perform of the interference mitigation processing on the signal transmitted by the first MU UE by using the first neural network, the one or more computer programs include computer-executable instructions that, when executed by the one or more processors individually or collectively, cause the electronic device to:
determine a number of processing steps for interference mitigation by the diffusion network; and
perform the interference mitigation processing on the signal transmitted by the first MU UE by using the first neural network, based on the determined number of processing steps.

15. The electronic device of claim 14, wherein, to determine of the number of processing steps for the interference mitigation by the diffusion network, the one or more computer programs include computer-executable instructions that, when executed by the one or more processors individually or collectively, cause the electronic device to:
determine a maximum number of steps for the interference mitigation by the diffusion network using a second neural network based on environmental information of the first MU UE; and
determine the number of processing steps for the interference mitigation by the diffusion network based on the maximum number of steps and the signal intensity-related information of the first MU UE.

16. The electronic device of claim 14,
wherein, to perform of the interference mitigation processing on the signal transmitted by the first MU UE by using the first neural network, the one or more computer programs include computer-executable instructions that, when executed by the one or more processors individually or collectively, cause the electronic device to:
iteratively perform T times of the interference mitigation processing;
wherein T is the determined number of processing steps, and
wherein, to a t-th interference mitigation processing in the T times of the interference mitigation processing, the one or more computer programs include computer-executable instructions that, when executed by the one or more processors individually or collectively, cause the electronic device to:
determine historical interference mitigation processing results;
weight the historical interference mitigation processing results;
predict an interference for the first MU UE based on a weighted result of (t−1)-th interference mitigation processing and the interference-related information corresponding to the first MU UE; and
perform the t-th interference mitigation processing based on the predicted interference.

17. The electronic device of claim 11,
wherein the signal intensity-related information includes at least one of a modulation and coding scheme (MCS) or a signal to interference plus noise ratio (SINR), and
wherein the channel-related information includes channel estimation results of UEs.

18. The electronic device of claim 14, wherein, to determine of the number of processing steps for the interference mitigation by the diffusion network, the one or more computer programs include computer-executable instructions that, when executed by the one or more processors individually or collectively, cause the electronic device to:
identify a modulation format in the signal intensity-related information;
based on the identified modulation format, determine a modulation order of the modulation format; and
based on the determined modulation order, determine a soft-decision area of the modulation order.

19. The electronic device of claim 18, wherein the modulation format includes one of quadrature phase-shift keying (QPSK), 16-quadrature amplitude modulation, 64-quadrature amplitude modulation, 256-quadrature amplitude modulation, or 1024-quadrature amplitude modulation.

20. One or more non-transitory computer-readable storage media storing one or more computer programs including computer-executable instructions that, when executed by one or more processors of an electronic device individually or collectively, cause the electronic device to perform operations, the operations comprising:
determining interference-related information corresponding to a first multiplexing (MU) user equipment (UE) based on first information of the first MU UE and a second MU UE, wherein the second MU UE and the first MU UE are configured to perform MU multiple input and multiple output (MIMO) multiplexing transmission, and wherein the first information includes at least one of MU pairing information, signal intensity-related information, or channel-related information; and
performing interference mitigation processing on a signal transmitted by the first MU UE by using a first neural network, based on the interference-related information corresponding to the first MU UE.
